(19) United States
(12) Patent Application Publication
(10) Pub. No.: US 2025/0315652 A1
(43) Pub. Date: Oct. 9, 2025

(54) SYSTEMS AND METHODS FOR A TRANSFORMER NEURAL NETWORK FOR PREDICTIONS IN RUGBY SPORTING EVENTS

(71) Applicant: STATS LLC, Chicago, IL (US)

(72) Inventors: Michael John HORTON, Wellington (NZ); Patrick Joseph LUCEY, Chicago, IL (US)

(73) Assignee: STATS LLC, Chicago, IL (US)

(21) Appl. No.: 19/169,603

(22) Filed: Apr. 3, 2025

Related U.S. Application Data
(60) Provisional application No. 63/574,666, filed on Apr. 4, 2024.
(60) Provisional application No. 63/774,261, filed on Mar. 19, 2025.

(51) Int. Cl. G06N 3/045; G06N 3/042

(52) U.S. Cl. CPC G06N 3/045; G06N 3/042

(57) ABSTRACT

A method of generating a set of predictions associated with a rugby game using an axial transformer neural network, the method including: receiving an input tuple, including a set of tensors representing game context, team strength, player strength, live team features, live player features, game events, and a super feature; inputting the input tuple into an axial transformer neural network by inputting each tensor from the set of tensors within a corresponding initial embedding layer; concatenating the initial embedding layers to form a single tensor; applying self-attention to the single tensor; mapping output embeddings from the axial transformer layers to target layers, each of the output embeddings being of a dimension of a target metric; and generating a set of target metric predictions for each of a set of players, one or more teams, and a match, based on the output embeddings from the target layers.

### CROSS-REFERENCE TO RELATED APPLICATIONS

This application claims the benefit of priority to U.S. Provisional Patent Application No. 63/574,666, filed Apr. 4, 2024, and to U.S. Provisional Patent Application No. 63/774,261, filed Mar. 19, 2025, the entirety of each of which is incorporated by reference herein.

### TECHNICAL FIELD

Various aspects of the present disclosure relate generally to machine learning for sports applications, in particular various aspects relate to a system and method for a transformer neural network for generating predictions for players and/or teams in a rugby sporting event.

### INTRODUCTION

With the rising popularity of sports, there is an increased desire for accurate granular predictions of what will occur during a sporting event. For example, predicting the number of tries scored for a player, both prior to and during the game, can be of particular interest to members of the media, broadcast (whether on the primary feed, or a second screen experience), sportsbook, and fantasy/gamification applications. Existing solutions are unable to accurately make such predictions. In particular, existing solutions may not adequately capture the correlations between team-mates, opposition, current lineups, and other contextual features of a particular match. Hence, new solutions are needed.

Unless otherwise indicated herein, the techniques and information described in this section are not prior art to the claims in this application and are not admitted to be prior art, or suggestions of the prior art, by inclusion in this section.

### SUMMARY

In some aspects techniques described herein relate to a method of generating a set of predictions associated with a rugby game using an axial transformer neural network, the method including: receiving an input tuple, including a set of tensors representing game context, team strength, player strength, live team features, live player features, game events, and a super feature; inputting the input tuple into an axial transformer neural network by inputting each tensor from the set of tensors within a corresponding initial embedding layer; concatenating the initial embedding layers to form a single tensor; applying self-attention to the single tensor through axial transformer layers of the axial transformer neural network; mapping output embeddings from the axial transformer layers to target layers, each of the output embeddings being of a dimension of a target metric; and generating a set of target metric predictions for each of a set of players, one or more teams, and a match, based on the output embeddings from the target layers.

In some aspects, techniques described herein relate to a method, wherein the rugby game is a union game, the super features includes an embedding to define elements of plays including line-outs, scrums, kicking, break-down, and ruck-and-mauls.

In some aspects, techniques described herein relate to a method, wherein the rugby games is a rugby league game, the super features includes an embedding to define how a team attacks and moves a ball during the rugby game and include an embedding for a predicted time of quick play the balls for each player in the rugby game.

In some aspects, techniques described herein relate to a method, wherein the axial transformer neural network is configured to accept inputs with different modalities.

In some aspects, techniques described herein relate to a method, wherein the super feature is determined based on broadcast data.

In some aspects, techniques described herein relate to a method, wherein the applying self-attention includes applying an autoregressive attention mask to a row in each layer of the single tensor.

In some aspects, techniques described herein relate to a method, wherein the target layers map the output embedding of final transformer layers to a required feature dimension of each target metric.

In some aspects, techniques described herein relate to a system for generating a set of predictions associated with a rugby game using an axial transformer neural network, the system including: a memory configured to store processor-readable instructions; and a processor operatively connected to the memory, and configured to execute the instructions to perform operations including: receiving an input tuple, including a set of tensors representing game context, team strength, player strength, live team features, live player features, game events, and a super feature; inputting the input tuple into an axial transformer neural network by inputting each tensor from the set of tensors within a corresponding initial embedding layer; concatenating the initial embedding layers to form a single tensor; applying self-attention to the single tensor through axial transformer layers of the axial transformer neural network; mapping output embeddings from the axial transformer layers to target layers, each of the output embeddings being of a dimension of a target metric; and generating a set of target metric predictions for each of a set of players, one or more teams, and a match, based on the output embeddings from the target layers.

In some aspects, techniques described herein relate to a system wherein the rugby game is a union game, the super features includes an embedding to define elements of plays including line-outs, scrums, kicking, break-down, and ruck-and-mauls.

In some aspects, techniques described herein relate to a system, wherein the rugby games is a rugby league game, the super features includes an embedding to define how a team attacks and moves a ball during the rugby game and include an embedding for a predicted time of quick play the balls for each player in the rugby game.

In some aspects, techniques described herein relate to a system, wherein the axial transformer neural network is configured to accept inputs with different modalities.

In some aspects, techniques described herein relate to a system, wherein the super feature is determined based on broadcast data.

In some aspects, techniques described herein relate to a system wherein the applying self-attention includes applying an autoregressive attention mask to a row in each layer of the single tensor.

In some aspects, techniques described herein relate to a system, wherein the target layers map the output embedding of final transformer layers to a required feature dimension of each target metric.

In some aspects, techniques described herein relate to a non-transitory computer readable medium configured to store processor-readable instructions, wherein when executed by a processor, the instructions perform operations including: receiving an input tuple, including a set of tensors representing game context, team strength, player strength, live team features, live player features, game events, and a super feature; inputting the input tuple into an axial transformer neural network by inputting each tensor from the set of tensors within a corresponding initial embedding layer; concatenating the initial embedding layers to form a single tensor; applying self-attention to the single tensor through axial transformer layers of the axial transformer neural network; mapping output embeddings from the axial transformer layers to target layers, each of the output embeddings being of a dimension of a target metric; and generating a set of target metric predictions for each of a set of players, one or more teams, and a match, based on the output embeddings from the target layers.

In some aspects, techniques described herein relate to a non-transitory computer readable medium, wherein the rugby game is a union game, the super features includes an embedding to define elements of plays including line-outs, scrums, kicking, break-down, and ruck-and-mauls.

In some aspects, techniques described herein relate to a non-transitory computer readable medium, wherein the rugby games is a rugby league game, the super features includes an embedding to define how a team attacks and moves a ball during the rugby game and include an embedding for a predicted time of quick play the balls for each player in the rugby game.

In some aspects, techniques described herein relate to a non-transitory computer readable medium, wherein the axial transformer neural network is configured to accept inputs with different modalities.

In some aspects, techniques described herein relate to a non-transitory computer readable medium, wherein the super feature is determined based on broadcast data.

In some aspects, techniques described herein relate to a non-transitory computer readable medium, wherein the applying self-attention includes applying an autoregressive attention mask to a row in each layer of the single tensor.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 are exemplary outputs of a transformer neural network for predictions at a game, team, and player level, according to example embodiments.

FIG. 3 is an exemplary output of the transformer neural network for live predictions of a player for twelve target actions during a game, according to example embodiments.

FIG. 4 is an example grid embedding of axial attention, according to example embodiments.

FIG. 5A is an exemplary model of a transformer neural network, according to example embodiments.

FIG. 5B is an exemplary model of the input tensors for the transformer neural network of FIG. 5A, according to example embodiments.

FIG. 6 is an exemplary set of calibration plots for all target predictions, according to example embodiments.

FIG. 7 is an exemplary mask matrix pattern, according to one or more embodiments.

FIG. 8A-8C are exemplary outputs of the transformer neural network for live predictions of a player for twelve target actions during a game, according to example embodiments.

FIG. 9 is an exemplary flow diagram for generating a set of predictions associated with a rugby sporting event using an axial transformer neural network, according to example embodiments.

FIG. 10 is an exemplary diagram of axial attention as described herein, according to example embodiments.

FIG. 11 depicts a flow diagram for training a machine-learning model, according to example embodiments.

FIG. 12A is a block diagram illustrating a computing device, according to example embodiments.

FIG. 12B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the present disclosure relate generally to machine learning for sports applications, in particular various aspects relate to a system and method for a transformer neural network for generating predictions for players and/or teams for a rugby sporting event (e.g., both Rugby League and Rugby Union). The system described herein may implement large-scale, in game outcome forecasting for match, team and players in possession-based sporting events by implementing an axial transformer neural network.

Given sequential data like text, language modeling may be defined as the task of predicting the next token in the sequence (which is a word or part of a word). In domains which are not text, but the input data is sequential in nature such as weather, the input sequence could be a combination of temperature, pressure and wind inputs. The output would be forecasting the temperature, wind and likelihood of rain in the next hour(s), day(s) and week(s). An exemplary model may first use a transformer type approach to project all the input sensors into the same frame-of-reference. Given the visual/spatial nature of the outputs, the model may use a diffusion model to predict the output from the initial transformer encoder. A key element may be the attention mechanism which assigns weights to different regions (spatially) but also the temporal elements (temperature, wind, pressure changes over time).

In sport, the input data may not be text, however the input may be sequential. For example, in rugby the input sequence can be a stream of events which give the rugby ball actions that occur (e.g., passing, kicking, carrying, rucking, tackling, etc.) as well as the corresponding timestamp(s). From this information, items that may be reconstructed in accordance with techniques disclosed herein include the score-line, time in the game, and/or the statistics of players and teams which makes up the live score-board or box-score. Player statistics may include tries scored, conversions, penalties, kicked, drop goals, tackles, carries, meters gained, passes, offloads, turnovers won, penalties, etc.). Team statistics may include tries scored, conversions, penalty kicks, drop goals, total points, possession, territory, tackles made, tackles missed, rucks won, scrums won.

Like weather forecasting, it may be interesting for viewers (whether the casual fan, coaches, betting customers) to have a prediction of the final outcome of the match, but also a prediction of the final statistics of both teams and players. End of the match predictions may be the most commonly sought-after, but micro predictions such as what will happen in the next 1, 2 or 5 minutes is also increasingly interesting.

Previous approaches to this task may rely heavily on market information (i.e., people placing stakes on the outcomes), and sports books most often use this information to estimate the total number of goals for each team. If the market is efficient where enough people place stakes on the game, sports books tend to derive all other predictions from this market information. Even though this may work for efficient markets for shots, goals, assists, penalties, powerplays at the team and match level, they do not work well at the player level. Other markets such as passes cannot be accurately estimated from total goals markets either.

To model player-based predictions (as well as inefficient markets like passes), a naive approach may be to take a supervised learning approach, where historical performance data of player is feed into a standard machine learning model (e.g., linear regression, support vector machine (“SVM”), Decision Forest, Boosted Gradient Tree, Multi-layer Perceptron) to provide a predicted output. This model may be learnt from historical data and is optimized to minimize the prediction error. Also these models may not accurately model the interaction between players as well as opponents. In accordance with techniques disclosed herein, to ensure these predictions sum up to the team totals, each player prediction may be normalized to a % of the team total. Also, the predicted minutes a player will play is estimated, so the final prediction may essentially a rates approach, where the total mins×percentage of team prediction of a specific statistic.

This approach may be less accurate when there is a change in game-state, such as a try being scored. Often in these situations, the predictions may need to be suspended until manual intervention by an expert to change any inaccurate predictions. This may be because the models do not take into consideration any of the other players or opponents. They may only be adjusted by the predicted team totals which do not model these interactions explicitly.

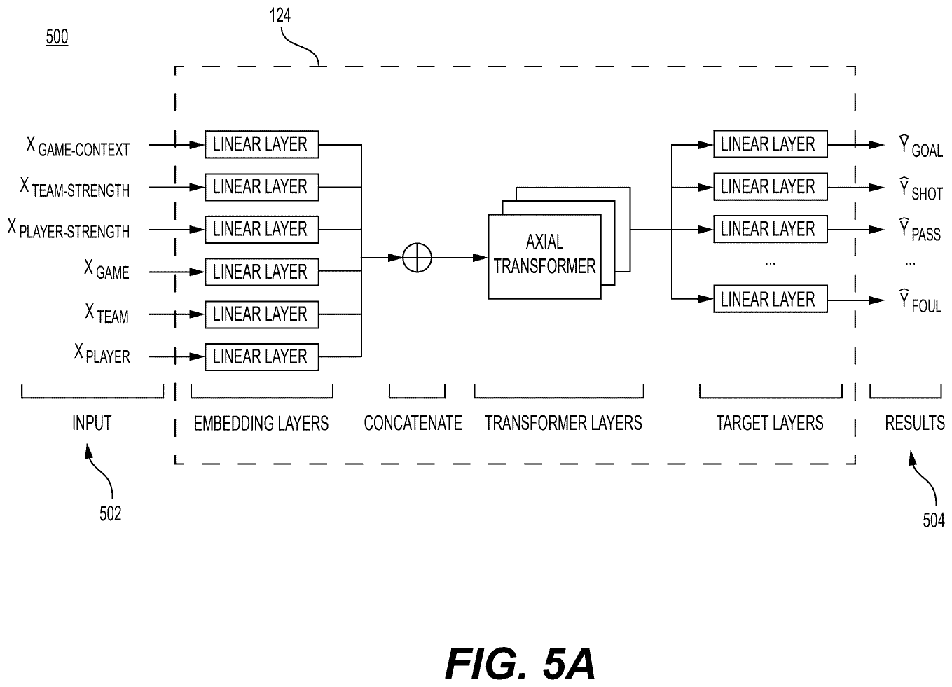

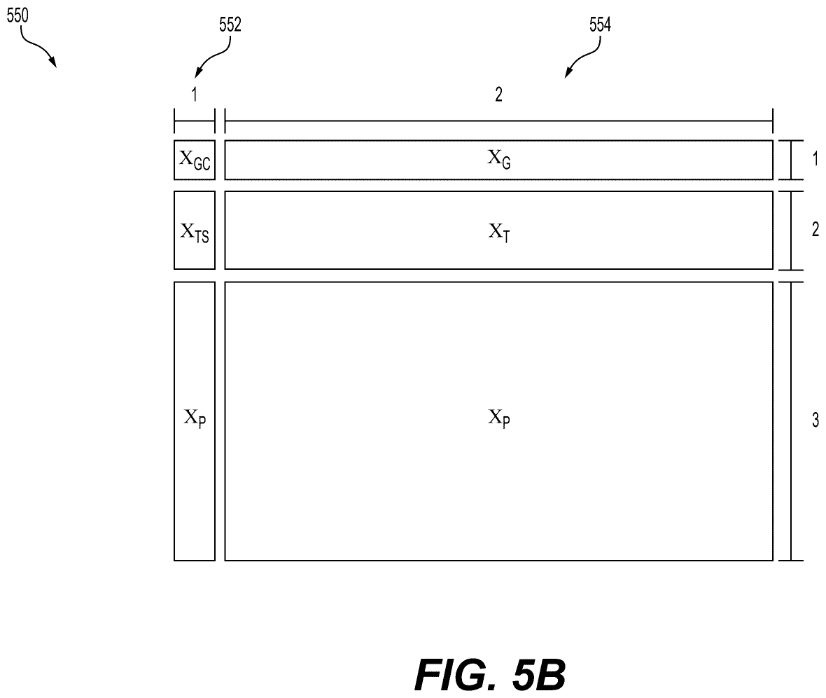

The system described herein may utilize a language modeling approach to predicting player, team, and match outcome. Similar to language modeling in text, or weather forecasting, the system may utilize an input stream of sports data which is event information as well as the aggregate of the game elapsed can be seen as “sensor” inputs (so the system may also include tracking data). The system may implement an axial transformer architecture as displayed in FIG. 5A below.

The systems and methods described herein may generate a team, player, or match prediction for rugby sporting events. A rugby sporting event may include a sporting event that includes may include both union rugby and rugby league games. For example, these In Rugby union games the following plays may occur: line-outs, scrums, kicking, break-down, ruck-and-mauls. In rugby league games, quick play the balls may occur and play may be defined as expansive play. These actions may be further defined through super-features and allow for more accurate predictions. Line-outs may be when the ball goes into the touch (e.g., out of bounds) and the teams line up in parallel for the team with possession to throw the ball back into play. Scrums may refer to a way of restarting a play after a minor infringement, where the forwards from each team bind together and push against each other while the scrum-half puts the ball in the middle. Both teams may then attempt to gain possession of the ball. Kicking may refer to the action of kicking the ball downfield (e.g., as place kicks, drop kicks, grubber kicks, punt, and kick for touch). Breakdown may refer to after a player is tackled and brought to the ground, where players from both teams compete for the ball. Ruck-and-maul may refer to a ruck, where the ball is on the ground and players from both teams bind together over the ball, where players must remain on their feet and use their feet to try and win the ball. This may further refer to a maul which occurs when a player carrying the ball is held up by one or more opponents, but the ball remains off the ground and is still in play. Ruck and mauls may be apart of rugby's contested ball phases, where team attempt to gain or retain possession of the ball. Quick play the ball may refer to the process of getting the ball back into play after a tackle. To execute this, the player with the ball may release the ball, roll away from the tackle, get to their feet, and present the ball for the scrum-half. The goal may be for players to exercise this quickly. Lastly, “expansive play or not” may define whether a style of attack includes moving the ball quickly and widely across the field. This may be done by wide passes or players running to expand the field.

The system and methods described herein may advantageously rely on a super feature/embedding to account for unique characteristics of a rugby sporting event. As such, the transformer described herein may incorporate a super feature or embedding layer to incorporate the rugby plays described such as line-outs, scrums, kicking, break-down, ruck-and-mauls for union games and “play the balls” and “expansive play” for rugby league. The super feature may incorporate historical information defining efficiency, timing, and success of these plays in historical matches for particular players. The super features may capture which players are on the field and their respective positions. The super features may also incorporate embeddings of particular aspects of play such as scrums, defensive and attacking kicking, line-outs (for Rugby Union), ruck-and-mauls (Rugby Union), play-the-balls, restarts. These may be strategic elements, and these may vary depending on whether a particular team is winning or losing, or if a team has had a player dismissed for a short-period of time (yellow-card/sin-bin) or for the remaining of the match. These super features may capture specific nuances of the rugby to enhance prediction performance. The model may further generate predictions for the outcome at particular time intervals.

The terminology used herein may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only.

Accurately forecasting the total number of actions that each player or team will complete during a match may be desirable for a variety of applications, including tactical decision-making, assigning odds to sporting events, and for television broadcast commentary and analysis. Such predictions must consider the game state, the ability and skill of the players in both teams, the interactions between the players, and the temporal dynamics of the game as it develops.

The systems and methods described herein may present a transformer-based neural network that jointly and recurrently predicts the expected totals for multiple (e.g., however many players on the field) individual actions at multiple time-steps during the match, where predictions may be made for each individual player, each team and at the game-level. The neural network may be based on an axial transformer that efficiently captures the temporal dynamics as the game progresses, and the interactions between the players at each time-step. The transformer may implement an axial transformer design that is equivalent to a regular sequential transformer. Described herein is a system that may be configured to make consistent and reliable predictions and efficiently makes approximately 75,000 live predictions at low latency for each game.

According to embodiments disclosed herein, a transformer neural network may receive inputs (e.g., tensor layers), where each input corresponds to a given player, team, or game. The transformer neural network may generate predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacent matrix defining the edges between the nodes (the absence of an attention mask thus implies a fully connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to) the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics for a respective sport. Player statistics may include tries scored, conversions, penalties, kicked, drop goals, tackles, carries, meters gained, passes, offloads, turnovers won, penalties, etc.). Team statistics may include tries scored, conversions, penalty kicks, drop goals, total points, possession, territory, tackles made, tackles missed, rucks won, scrums won.

The training of the transformer-based neural network may include choosing a corresponding loss function for the distribution assumption of each output target. For example, the loss function may be the Poisson negative log-likelihood for a Poisson distribution, binary cross entropy for a Bernoulli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

Rugby sporting events may be for a sport or game that can be viewed as a sequence of actions such as plays, that are carried out by the players with the objective of scoring points and ultimately winning the match. The ability to accurately forecast, both prior to and live during a game, the total number of each such action that will be carried out by each player, and by each team, during the entire match is important for a variety of applications, such as: determining the starting lineup and substitutions; evaluating player and team performance; setting statistical odds for occurrence of events; and supporting commentary and analysis during live broadcasts.

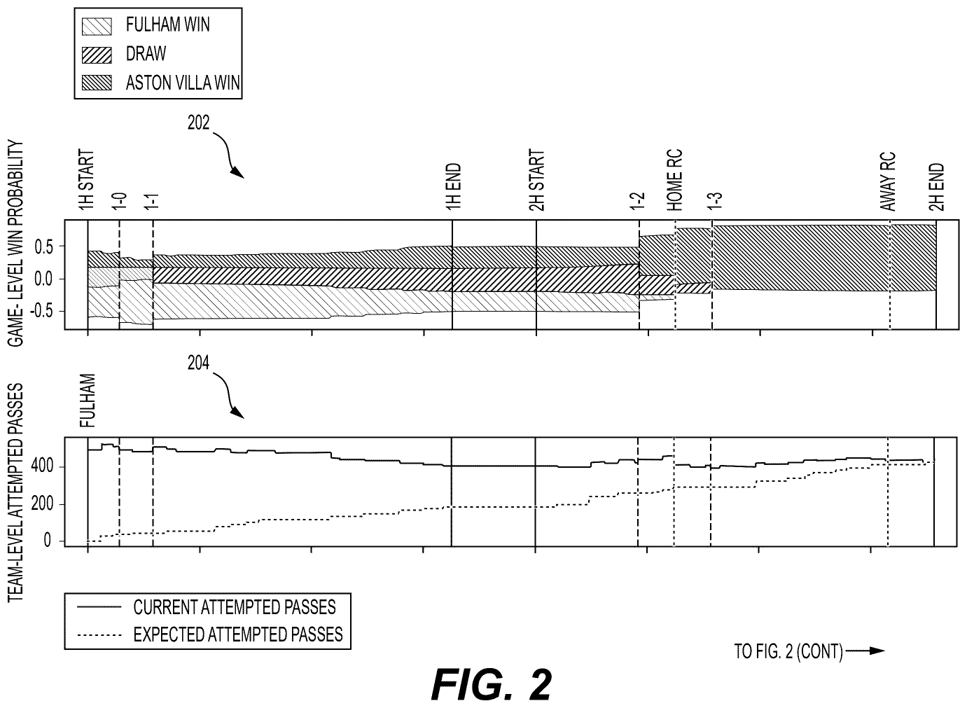

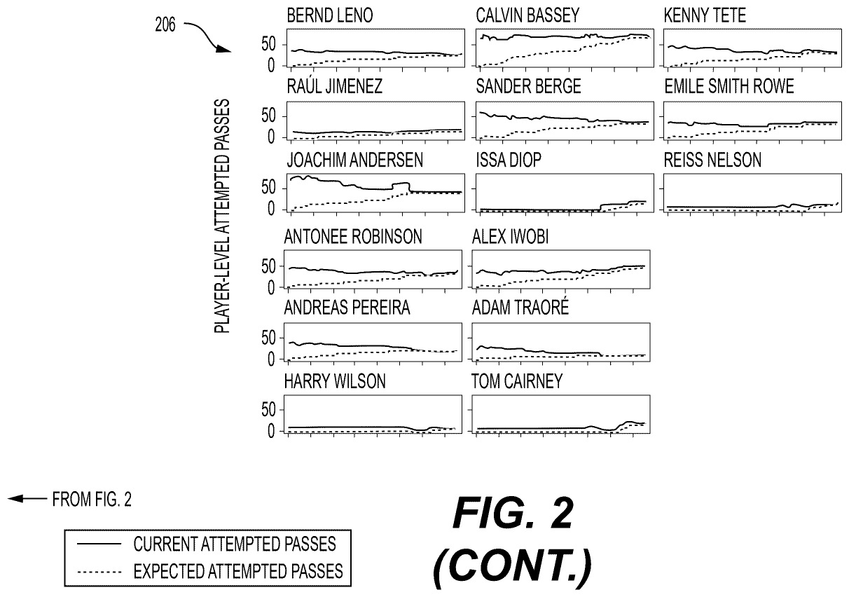

Forecasting action totals has a direct application in setting odds for sports events that occur, where the ability to create markets on individual players and teams that are updated during games is appealing for the variety of market related products it entails. Traditional approaches to setting odds, may typically involve human intervention, will not scale to the number of possible markets, and purely algorithmic solutions are necessary. Furthermore, the data and analytic methods used in setting odds for a sporting event may be used by professional sporting clubs/players to improve their decision-making and competitive performance. The systems and methods described herein may implement a single neural network model that jointly makes forecasts of the total number of actions made by each agent (e.g. a player, a team, or the overall game-state), for multiple actions, and at multiple time-steps during a match. An example of predicted actions may be displayed in FIG. 2 discussed below. The model may accept multi-modal input features on all agents, and features that denote the a-priori strength and playing style of each player and team. This model may be characterized by a simple network structure, that still captures the interactions between the agents since the match started and uses this shared state to forecast the final totals for each action by each agent.

The model may be based on the transformer, a neural network component that has proven to be an effective and reliable learner across many domains, due to its apparent ability to capture interactions and dependencies across sequential, grid, and graphical data structures. Moreover, the transformer has been shown to effectively integrate and learn from the heterogeneous inputs inherent in multi-modal settings. For example, transformers may be implemented by language modelling, and the transformer may currently be the backbone of state-of-the-art models in computer vision, vehicle motion forecasting, weather forecasting and drug discovery.

The actions that occur during a rugby sporting event may be the product of a complex system of interactions between players, teams and the game-state, and the task of predicting the total number of actions that will accrue to an individual agent over the duration of the match has several considerations that may contextualize the prediction. An exemplary forecast that the model may predict at a particular point in time during the game how many ties the player will score. The prediction may be conditioned by several factors, including, but not limited to:
Historical performance for particular actions such as line-outs, scrums, kicking, break-down, ruck-and-mauls, “quick play the balls,” and “expansive plays.”
The number of passes already made by the player.
A current line-up in the sporting event.
The offensive strength of the player's team-mates, and the strategy the team is performing.
The defensive strength of the opposition team players, and their strategy.
The game states, i.e. the current score, remaining time, number of sent-off players, etc.
The game context, i.e. the competition stage the game is played in e.g., whether it is a final in a knock-out tournament, or a meaningless end-of-season game.
The expected time remaining until the player is substituted or the game ends.
The momentum of the current game state, e.g. whether one team has been dominating the game-play recently.

The model described herein may be configured to predict particular outcomes or aspects for a player, team, and/or match. The model may incorporate the super features described above. The super features may incorporate embeddings of particular aspects of play such as scrums, defensive and attacking kicking, line-outs (for Rugby Union), ruck-and-mauls (Rugby Union), play-the-balls, restarts. These may be strategic elements, but these may vary depending on whether a team is winning or losing, or if the team has had a player dismissed for a short-period of time (yellow-card/sin-bin) or for the remaining of the match. These super features may capture specific nuances of rugby to enhance prediction performance. The predictions may be generated for end of game, halves, or at set time intervals.

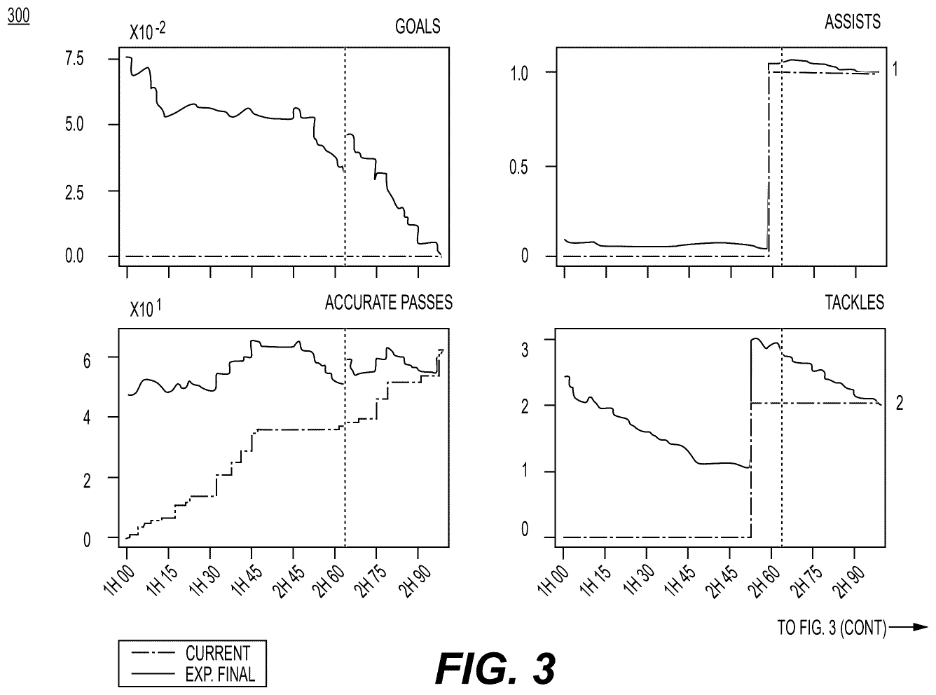

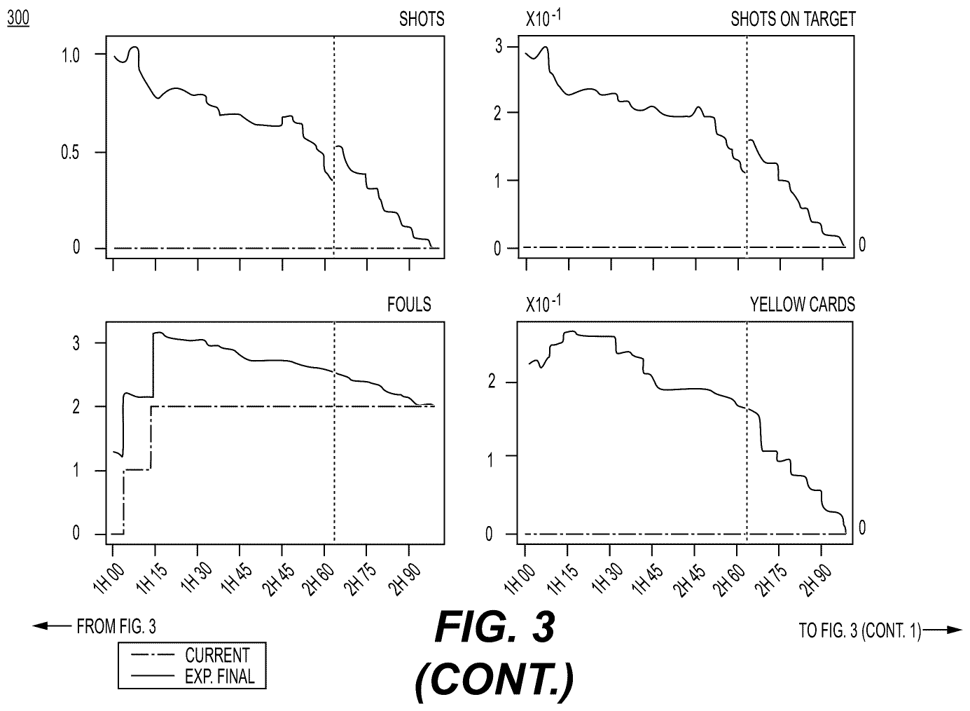

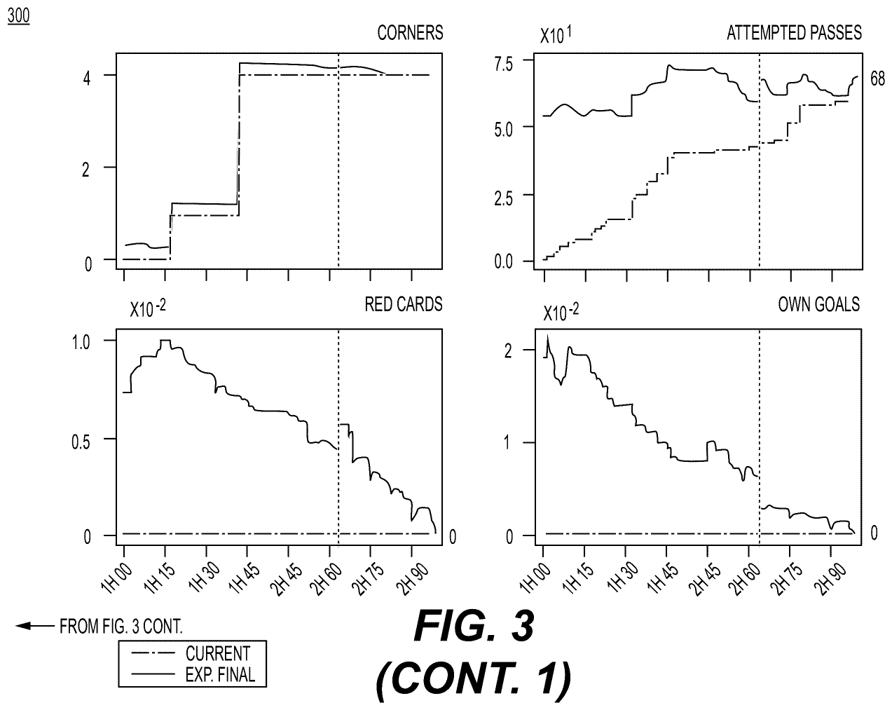

The model described herein may need to be consistent in the predictions that it makes for the various actions. The consistency may be include scenarios such as, the number of tries predicted for all players on a team must be no greater the projected team tries. The model may also be sensitive to the correlations between actions: a team that is dominant (e.g., has higher success for the plays defined in the super feature) will tend to be more likely to score more tries. The model may have the capacity to make joint predictions on the game totals of all actions by learning the correlations and patterns between the actions. Moreover, since the predictions are updated as the match progresses, the predictions may need to be temporally consistent in the sense that the predicted totals should never be less than the actual running totals, be smooth locally (with the exception of when significant events take place, such as goals), and converge to the actual totals at the end of the match. The model may also capture in-game dynamics, such as shifts in momentum, or the effects of points, player dismissals, etc. as the rate that actions occur varies with the stage of the game, and with key events. FIG. 3 may be an example of predictions for a single player and may be discussed in further detail below. The transformer model described herein may:
Accepts inputs on a set of players with no implicit ordering, or requirement that the cardinality of the set is fixed.
Accepts inputs with different modalities, e.g. player, team, game-state, and both pre-game and in-game.
Makes consistent predictions for multiple separate actions and makes sequential predictions that are temporally consistent, and can capture in-game momentum and dynamics.

The transformer neural network described herein may use only axial transformer layers and fully-connected linear layers, may be able to fulfil these requirements. The model may be based on a novel formulation of the axial transformer that efficiently integrates the temporal dynamics of the game as it progresses, and the interactions between players within each time-step in simple, efficient and principled approach. The learned embeddings output by the final transformer layer may be used to forecast the total of each action for each player, by inputting them into a single linear layer.

This model architecture may be considered efficient, where there are no duplicate features in the input. The model may make multiple predictions at each time-step. For example, it may forecasts totals for each of twelve actions for each player in the match-day squad and for the two teams, and also predicts the game outcome at the game-state level, up to approximately 505 predictions per time-step, and predictions may be made temporally throughout the game (e.g., approximately 150 time per game). In some examples, predictions may be made at set time intervals or after each try. At inference time, the model may achieve sub-second latency on commodity CPU hardware and may be appropriate for running in a real-time setting.

Conventional techniques do not work for the task of making such consistent real-time player-level forecasts during matches from a single model. The model described herein has been tested empirically and shown to obtain consistent performance across all the target actions. Ablation tests have been performed that demonstrate that both player interactions and temporal dynamics contribute to fully capturing the current game state and subsequently making predictions.

Sports analysis may be a research field that has developed significantly in recent years, enabled by a number of factors, including: the increased interest and commercialization of professional sports and the related broadcasting and betting industries; the availability of detailed game data; and the relatively constrained nature of games in terms of location and agents make it suitable for algorithmic analysis. A particular area of research is forecasting which may include predicting game outcomes, either prior to or during the game.

Historically, forecasting sporting events has been restricted by the unavailability of detailed data to coarse targets, such as the outcome of a game, or the number of goals scored by each team, and predictions were made pre-game, typically based on the results of prior games.

The collection of fine-grained event tracking data in professional rugby may allow for predictions to be made on actions beyond just tries. Event tracking may be captured by human operators who log all action events, along with contextual attributes, such as the time, location, identity of involved players, etc. These data allow for predictions to be made on actions other than just tries, and for each individual player. Furthermore, event data may allow for predictions to be made in-game, where forecasts are made for individual players on actions, and are adjusted as the game proceeds and actions are recorded. The event data may be further contextualized by combining it with player tracking data, so that the location and velocity of each player is known throughout the match.

Event and tracking has enabled models to make short-term predictions, such as estimating the next action event, or the value of the next event or events. Estimating the game outcome as the match proceeds, often known as live win probability, may also be possible with the game context extracted from event and tracking data.

The system described herein describes a transformer for large-scale forecasting of multi-modal metrics for a large number of actions in a recurrent setting.

The transformer architecture is initially designed for natural language processing (“NLP”) tasks such as machine translation, and is based on an encoder-decoder model. Subsequently, the encoder component of the transformer has been shown to be effective on its own on many NLP tasks, and that it was possible to leverage large unlabeled datasets in pre-training, and that the pre-trained model would transfer easily to directed tasks with minimal fine-tuning. The transformer has subsequently shown itself to be effective in many other domains with structured sequential or grid-based data, including image recognition, drug discovery, and weather forecasting. Transformers may also be used as the backbone of multi-modal architectures that fuse text and image inputs.

The core operator in the transformer may be the attention mechanism which operates over a single dimension, such as a sequence of word tokens in NLP tasks. The axial transformer may extend this to operate alternately over the row and column of a pixel in an image. The approach may be applied to learning the joint movement of agents over time.

Many approaches described above for action prediction problems are single-task approaches, where predictions are made for a single action and a single player or team only, or for both teams at a time. However, multi-task learning, making simultaneous predictions on multiple targets, has been shown to improve performance on all targets. In the case of transformers, multi-task learning may be employed during pre-training and has been shown via experiments to improve performance on downstream tasks.

Transformers disclosed herein are also effective for multimodal learning and have been used to integrate inputs of different modalities into a single model framework.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competitive landscape. A sports machine learning model may be trained to adjust one or more weights, layers, nodes, biases, and/or synapses to associate certain sports statistics in view of a competition landscape. For example, a win indicator for a given team may automatically be correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity

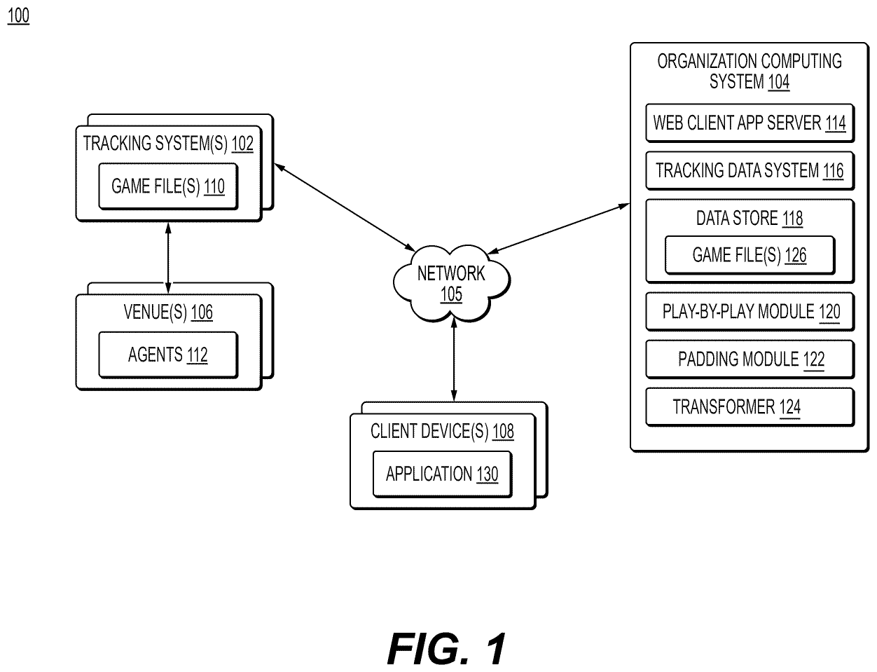

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105. The computing environment 100 may be implemented for large scale in-game outcome forecasting for match, team, and player predictions by implementing an axial transformer neural network. Although described in relation to soccer games, the techniques, may be applied to all rugby sporting events.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, padding module 122, and/or transformer 124. Each of tracking data system 116, play-by-play module 120, padding module 122, and transformer 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for transformer 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean. The computing system 104 may further include a transformer 124, wherein the components may be further described in FIG. 5A below.

Accordingly, for each player, tracking data system 116, play-by-play module 120, and padding module 122 may work in conjunction to generate a raw data set and a padded data set for each player.

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format. The data store 118 may further be configured to store the one or more predictions for the teams, players, and matches as determined by the transformer 124.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to generate one or more of a player, team, and/or match prediction. The content that is displayed to client device 108 may be transmitted from web client application server 114 to client device 108, and subsequently processed by application 130 for display through a graphical user interface (GUI) of client device 108.

FIG. 2 is an exemplary output of the transformer neural network for predictions at a game, team, and player level, according to example embodiments. FIG. 2 shows exemplary predictions (e.g., forecasts) from the transformer described herein for a sporting game (e.g., Fulham (1) vs. Aston Villa (3) on 19 Oct. 2024). Although this example, may depict the system as applied to soccer, these techniques may also be applied to rugby sporting events. As time progresses with the x-axis, the probability of each outcome may updated to account for the current game state. Updates to player predictions may continuously (e.g., throughout the game) reflect that individual player predictions may add up to overall team predictions for particular statistics. This means that team predicted statistics may be a total of predicted player statistics. A selection of key events may be by dashed vertical lines, including goals (blue), red cards (red) and start and end of each half (black). Graph 202 may display game level predictions, graph 204 may display team level predictions, and graph 206 may show play level predictions. FIG. 3 is an exemplary output 300 of the transformer neural network for live predictions of a player for twelve target actions during a game, according to example embodiments. FIG. 2 and FIG. 3 display exemplary outputs from the transformer neural network described herein.

The model described herein (e.g., via transformer 124) may accept input features for different agents, and over a time-series spanning a match, and may implement a single transformer encoder backbone to learn embeddings that subsequently make predictions on multiple actions for each agent. The model backbone may be a series of axial transformer encoder layers, where each layer applies attention separately along the temporal and agent dimensions.

### Preliminaries

The An objective of the model may be to predict the end-of-match totals for various actions for all agents involved. Each target may thus be a discrete random variable Ya,p,t, where a is the action, p is the agent and t is the time-step. Ideally, the model may predict the joint distribution of all targets P(Υ):Υ={Ya,p,t|a∈A, p∈P, t∈T}, where A, P and T are the sets of actions, agents and time-steps, respectively. However this is intractable: the space of possible outcomes is at least 2^{|A|×|P|×|T|} (assuming that each Ya,p,t has only two possible outcomes).

The model described herein be trained to learn the marginal distribution for each target, P(Ya,p,t)=ΣY\Ya,p,t P(Υ), where Υ\Ya,p,t is the set of all targets except Ya,p,t. The model may approximate the joint distribution, and use this to determine the marginal distributions, and thus ensure consistency between the distributions for each target.

Matrices and tensors described herein may be denoted in boldface capitals, e.g. M, and vectors as lowercase, e.g. v. Subscripts may be used to distinguish objects, e.g. vᵢ or M_{row}. Bracketed superscripts may be used to distinguish entities with the same structure, e.g. input examples X⁽ⁿ⁾ or embeddings E⁽ⁿ⁾. In ambiguous situations, indexing into vectors, matrices and tensors may be denoted by the notation Mᵢⱼ, which is the i-th element of the first dimension and j-th element of the second dimension, etc. All enumerations used for indexing start with 1.

### Data

The models may be trained on a set of N training examples X. The granularity of each training example is a single match, and for each match n there are T (n) time-steps where an action event occurs. There may be P⁽ⁿ⁾ players in the match-day squad, and 2 teams for each match n.

Each training example may be a tuple X⁽ⁿ⁾, Υ⁽ⁿ⁾, where X⁽ⁿ⁾ is the tuple of input tensors, and Υ⁽ⁿ⁾ is the tuple of target tensors for match n. FIG. 5B is an exemplary model 550 of the input tensors for the transformer neural network of FIG. 5A, according to example embodiments. The input tensors X⁽ⁿ⁾, may be arranged along the time and agent dimensions according to the arrangement of FIG. 5B. The columns may represent the agent (e.g., the player, team, and match respective tensors), and rows may represent the temporal aspect of a match. Column 552 represents the initial input of the tensors described above. Column 554 depicts how the input tensors are provided temporally throughout a game.

The input tuple X⁽ⁿ⁾ contains the following tensors:

$${X}_{player}^{( n )} ∈ {R}^{{T}^{( n )} x {P}^{( n )} x {D}_{player}}$$

is the tensor of live player features, where D_{players} is the dimension of the player feature vectors. The features are for

$${X}_{p l a y e r}^{( n )}$$

contains indicator features for the player's position and team and running total of the actions already made by the player.

$${X}_{p l a y e r - s t r e n g t h}^{( n )} ∈ {R}^{{P}^{( n )} x {D}_{player - strength}}$$

is the tensor of player strength features, where D_{player-strength} is the dimension of the player strength feature vectors. The player strength features may be configured to capture the a-priori strength of the player, and are primarily aggregate statistics of the player's action in previous games, such as, for example, the mean number of passes in the previous 5 games, the maximum fouls conceded in the previous ten games, etc. In addition, there are features for the time since the previous match, distance from the player's home ground, and distance from the previous match location.

$${X}_{team}^{( n )} ∈ {R}^{{T}^{( n )} x 2 x {D}_{t e a m}}$$

is the tensor of live team features, where Dₜₑₐₘ is the dimension of the team feature vectors. The features for

$${X}_{team}^{( n )}$$

contain indicator features for the team and running totals of the actions already made by t the team, similar to the live player features.

$${X}_{team - strength}^{( n )} ∈ {R}^{2 x {D}_{t eam - strength}}$$

is the tensor of team strength features, where D_{team-strength} is the dimension of the team strength feature vectors. The team strength features are primarily aggregate statistics of the team's action in previous games, similar to the player strength features.

$${X}_{g a m e}^{( n )} ∈ {R}^{{T}^{( n )} x {D}_{g a m e}}$$

is the tensor of live game state features, where the feature vector is of dimension D_{game}. The game state feature contains attributes of the current event, such as the event-type, the game-clock time, and the event location.

$${X}_{g a m e - context}^{( n )} ∈ {R}^{{D}_{g ame - context}}$$

is the game context features vector of dimensions D_{game-context}. The event context features capture the context in which the game is played, such as indicator features for the competition (such as what league the game is played in), the hour the game is played in, etc.

The input tuple may further include a super embedding (also referred to as a super feature) not depicted in FIG. 5A as a tensor input. The super embedding may capture most relevant information about a contextual aspect of the game (e.g., what is happening during the game, for the particular sport, for a particular lineup, etc.). In some examples, the super embedding may incorporate aspects of one or more of the other tensors. In some examples, the super embedding may not be a separate embedding, but rather refer to particular embedding elements of one or more of the other tensors. The super embedding may include embeddings that incorporate embeddings which captures scrums, defensive and attacking kicking, line-outs (for Rugby Union), ruck-and-mauls (Rugby Union), play-the-balls, restarts as described above.

An important attribute of this input scheme may be that features are not duplicated. The features may be categorized by their modality, such as player-level, team-frame-level, game-level, and they are included in the corresponding tensor. The model may rely on the attention mechanism in the transformer layers to learn which features at each modality are relevant to predictions at other modalities.

The target tuple Υ⁽ⁱ⁾, contains tensors for each of the modelled actions for each player and/or team. For a given action a, the target tensor may contain the remaining number of actions for each player in a tensor

$${Y}_{a}^{( i )} ∈ {R}^{{T}^{( i )} x {P}^{( i )}} .$$

For example if a is the number of shots, for player p and for time-step t,

$${( {Y}_{a}^{( n )} )}_{pt}$$

may be the number of shots made my player p in the interval (t, T⁽ⁿ⁾]. Using the remaining action count as ground-truth, rather than the total count, may allow for the count to be modelled using the Poisson distribution, which is appropriate for many of the action targets considered here.

### Axial Transformer

The axial transformer may be a key component of the model described herein. The system described herein may include a simple variation of the axial transformer that is simple, easy to implement using standard frameworks such as PyTorch, and may be computationally efficient implementation of the regular sequential masked self-attention.

Masked self-attention may be an operation on a sequence of embedding vectors contained in a matrix S:=[e₁, e₂, . . . , eₛ]^{T} of length S:

$$Attention ( K , Q , V , M ) := Softmax ( A ) V , where \qquad ( 1 )$$

$$A = \frac{M + {KQ}^{T}}{\sqrt{d}} \qquad ( 2 )$$

where K, Q, V∈R^{S×D} are matrices computed from S using a linear transformation (e.g. K:=SW_{K} for some learnable Wₖ∈R^{D×D}), and M∈R^{S×S} is a mask matrix that describes which elements in the sequence can be attended to. The mask matrix may be application specific, and is constructed as Mᵢⱼ=0 if Sᵢ can attend to Sⱼ, and —∞otherwise. The Softmax operator is applied row-wise using the element-wise operators exponential exp and Hadamard division:

$$Softmax ( A ) := \frac{exp ( A )}{n {1}^{T}} , where \qquad ( 3 )$$

$$n = exp ( A ) 1 , \qquad ( 4 )$$

where 1 where 1 is the ones vector of dimension S, and the vector n∈R^{s} is the vector containing the normalizing factor for each row and thus normalizes each row of exp(A) so that each row sums to 1.

Given an input S, the Attention( ) operator returns R∈R^{S×D}, where each embedding vector (R)ᵢ is used to update the corresponding embedding vector(S)ᵢ in the subsequent layers of the transformer block.

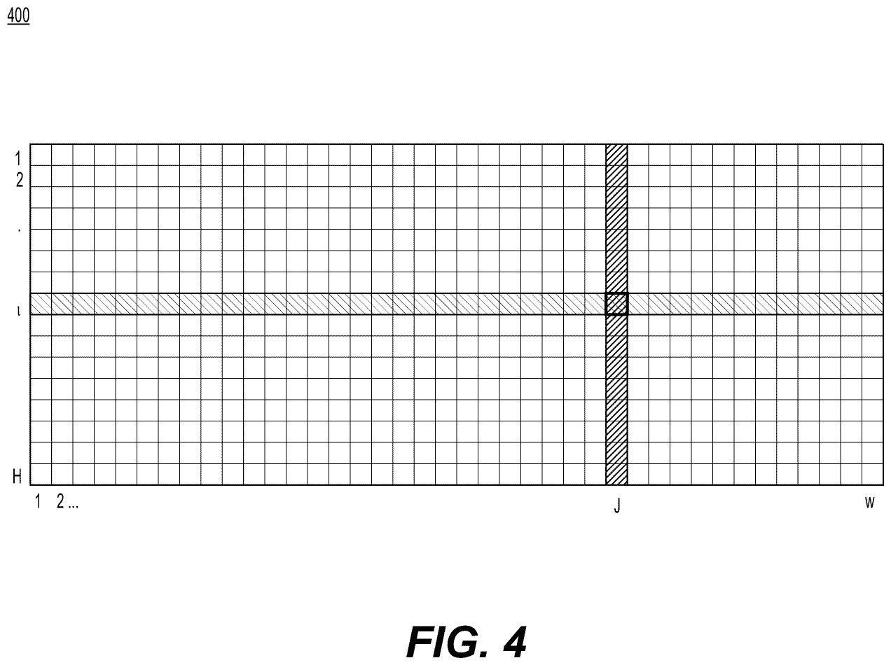

In contrast to sequential attention, axial attention may operate on a grid of embedding vectors, contained in a H×W×D-dimensional tensor G, where the Attention( ) operator is applied to each row and to each column of the grid independently, obtaining the output tensors R^{row}, R^{col}∈R^{H×W×D}, and then the outputs from these operations are aggregated. The embedding vector (G)ᵢⱼ is updated from the outputs of the Attention( ) operation on row i and column j. This may be depicted in FIG. 4.

FIG. 4 is an example grid embedding 400 of axial attention, according to example embodiments. Axial attention may be used on a grid of embeddings. For the given cell (G)ᵢⱼ (with a shaded border), self-attention may be applied over the highlighted column G·ⱼ and masked self-attention over the highlighted row Gᵢ.

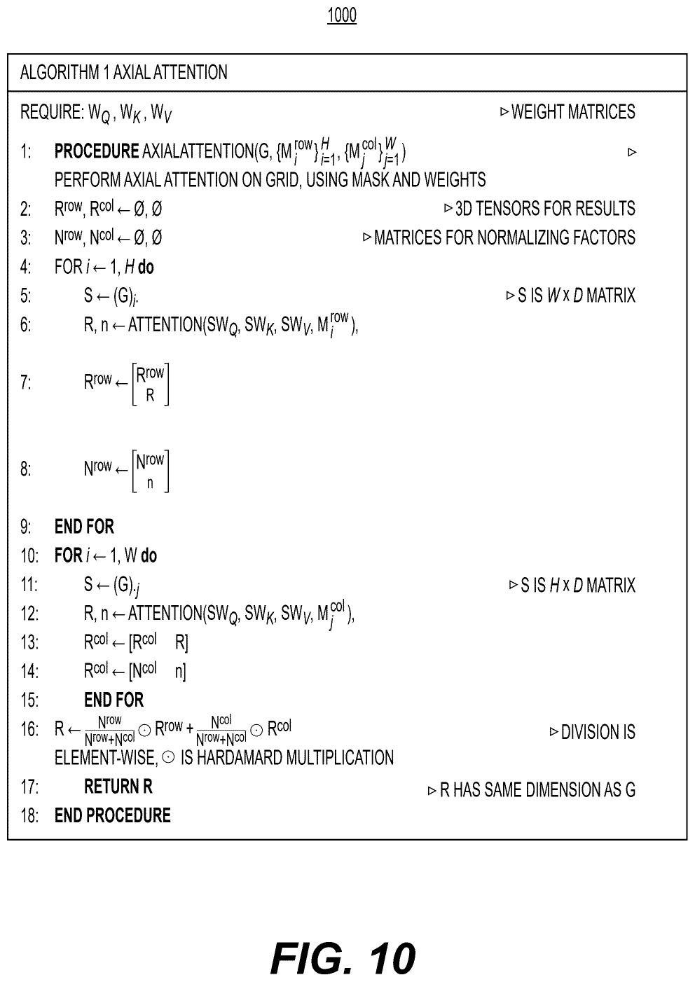

Intuitively, it may be desirable that the axial attention operation for updating (G)ᵢⱼ should attend equally to both the embedding vectors in row i and in column j. This may be achieved by simply adding (R^{row})_{i,j}, i.e. the j-th element of the output of the row attention operation on row i, with (R^{co}I)ᵢⱼ, the output of the i-th element of the output of the column attention on row j. However, since the respective row and column Softmax( ) operations have been individually normalized, the system may re-normalize over both using the row and column normalizing factors (n^{row})ᵢ and (n^{col})ⱼ respectively. Naively, this approach may attend to the embedding vector (G)ᵢⱼ twice, in both the row and column operation, however this can be avoided by asserting that this vector is masked in either the row or column Attention( ) operation. Algorithm 1, depicted in FIG. 10, below may display how axial attention is described herein.

During a single AxialAttention( ) operation, H row Attention( ) operations on sequences of length W, and W column Attention( ) operations on sequences of length H, are performed. Given that the runtime and storage complexity of the Attention( ) operation is quadratic in the sequence length, then the overall complexity may be O((H+W)HW).

In contrast to conventional systems using axial attention where the row and column attention operations are applied sequentially using distinct layers: R=(Attention_{col}∘Attention_{row}) (G), here the system adds the weighted outputs of the row and column operations and share the attention weights between these operations.

Moreover, this additive axial attention operation may be equivalent to regular masked sequential attention with the following attention mask.

The grid of embedding vectors may be “unraveled” to a row-major sequence of vectors S=[G₁₁, G₁₂, . . . , G_{1W}, G₂₁, . . . , G_{HW}]. Let P∈{0, 1}^{HW×HW} be the permutation matrix that reorders a column major sequence to row-major, P[G₁₁, G₂₁, . . . , G_{H1}, G₁₂, . . . ,G_{HW}]=S. The axial attention described above is equivalent to sequential attention on S with the following attention mask:

$$M := {M}^{r o w} + P ( {M}^{c o l} ) {P}^{T} , where \qquad ( 5 )$$

$${M}^{row} := diag ( {M}_{1}^{row} , {M}_{2}^{row} , … , {M}_{H}^{row} ) \qquad ( 6 )$$

$${M}^{c o l} := diag ( {M}_{1}^{c o l} , {M}_{2}^{c o l} , … , {M}_{W}^{c o l} ) \qquad ( 7 )$$

where

$${M}_{i}^{row} and {M}_{j}^{col}$$

are the mask matrices for row i and column j, respectively. The details of a sketch proof of the equivalence may described in further detail below.

This reformulation may imply that any theoretical results, bounds, intuitions and heuristics that apply to regular masked self-attention will also apply to this form of axial attention. The time and storage complexity on this sequential self-attention operation is O(H²W²), whereas axial attention is sub-quadratic in the sequence length HW.

The axial attention operator may be contained in an axial transformer layer using a similar structure to regular sequential transformer layers. Axial attention is applied to the input grid, and this is followed by the standard feed-forward, layer-norm and skip connection components.

The grid structure inherent in axial attention may be appealing for this setting of recurrently forecasting player performance; consider an embedding vector (G)ᵢⱼ, representing the state of a player i at a particular time-step j. In this case, the state contained in the embedding should be conditioned on all previous states for player i, and also on the states of all other agents in time-step j. To update (G)ᵢⱼ a row (temporal) attention operation Attention(Gᵢ) may be applied that attends only to previous embedding vectors {(R)_{ij′}|∀j′<j}, which can be implemented using as the mask an upper-triangular mask matrix. This may allow for the axial attention mechanism to capture the dynamics in the input features for each player over time, and thus can model changes in momentum, player fatigue, recency of significant in-game events, etc. Similarly, a column (agent) attention operation Attention(G. j) attends to all embedding vectors in the column {(G)_{i′j}|∀i′}, thus permitting the axial attention mechanism to capture interactions between players.

### Model

A model disclosed herein may be implemented as a multi-layer neural network consisting of three groups of layers as displayed in FIG. 5A. FIG. 5A is an exemplary model 500 of the transformer 124, according to example embodiments. The tensors in the input 502 are passed through the embedding layers to standardize the feature dimension and then are stacked into a single tensor. This tensor is passed through the transformer layers, and the output embeddings are used to compute the outputs 504 for each of the action targets. The transformer 124 may include:
Embedding layer that maps the component tensors of the input into tensors with a common feature dimension and concatenates them into a single input tensor.
Axial transformer layers that perform attention along the temporal and agent dimensions.
Target layers that map the output embeddings from the last transformer layer into tensors with the required feature dimension of each target metric.

Embedding Layers. The embedding layer is a linear transform on each input tensor that maps it to a tensor with a common feature dimension D. For example, with the player input tensor the linear transform is a function ƒ_{player}: R^{P}^{⁽ⁿ⁾}^{×T}^{ⁿ}^{×D}^{_{player}}→R^{P}^{⁽ⁿ⁾}^{×T}^{ⁿ}^{×D}. The output of the linear layer may be a tuple of tensors, each with a common feature dimension, and so they may be concatenated along the temporal and agent dimensions to form a single tensor, in the following arrangement:

$${E}_{0}^{( n )} = [ \begin{matrix}fgame - context ( {X}_{game - context}^{( n )} ) & fgame ( {X}_{game}^{( n )} ) \\ fteam - strength ( {X}_{team - strength}^{( n )} ) & fteam ( {X}_{team}^{( n )} ) \\ fplayer - strength ( {X}_{player - strength}^{( n )} ) & fplayer ( {X}_{player}^{( n )} )\end{matrix} ]$$

$$∈ {ℝ}^{H \times W \times D} , where H = {P}^{( n )} + 2 + 1 , and W = {T}^{( n )} + 1 .$$

The embedding tensor E⁽ⁿ⁾ may thus be a grid of embedding vectors eᵢⱼ∈R^{D}, where each embedding vector contains the information about the corresponding agent at a time-step. Each row of E⁽ⁿ⁾ may contain a time-series for a particular agent such, as a player, a team or the game-state. Each column of E⁽ⁿ⁾ is the set of embedding vectors for each agent at a particular time-step.

The tensor

$${E}_{0}^{n}$$

is then passed through a series of L axial transformer layers, as detailed in above. Each layer [symbol] may accept a tensor

$${E}_{l - 1}^{n}$$

and outputs a tensor

$${E}_{l}^{n}$$

of the same dimension. An autoregressive attention mask (i.e. a strict uppertriangular mask) may be applied to the row (temporal) attention in each layer so that the embeddings in the current time-step i can only attend to previous time-steps [1 . . . i−1]. The column (agent) attention may allow agent j in time-step i to attend to all other agents the current time-step.

The output

$${E}_{L}^{n}$$

of the final layer may be updated by the transformer layers to integrate information from all input features up to and including the current time step. This embedding may then be used to directly make predictions for the required targets.

The final layer (e.g., target layers) of the model may be a set of linear layers that map the output embeddings

$${E}_{L}^{n}$$

of the final transformer layer to the required feature dimension of each target metric. For each action target and modality (e.g. player, team or game), a linear layer is required that is shared over all agents and time-steps. For example, if the target is the final goal count for a player, and we choose to model this as a Poisson distribution it is necessary to estimate a single parameter λ for each player at each time step. The linear layer may be a function hₐ:R^{P}^{ⁿ}^{×T}^{ⁿ}^{×D}→R^{P}^{ⁿ}^{×T}^{ⁿ}. Different distribution assumptions can be made and the only difference in the model is to the output parameter dimension of the corresponding linear layer. The model may utilize several such assumptions, including Bernoulli, Poisson, log Gaussian, and “model-free” discrete distributions.

### Training

During training, a corresponding loss function for the distribution assumption of each output target may be implemented, e.g. Poisson negative log-likelihood for the Poisson distribution, binary cross entropy for the Bernoulli distribution, etc. The losses may have been computed according to the ground truth value for each target in the training set, and the loss values were summed. The model weights may have been updated from the total loss using an optimizer, and the learning rate may have been adjusted on a schedule by cosine annealing, without warm restarts.

### Inference

The model described herein may be designed to run in a live setting, where the invocation of the model is triggered by a key event occurring within the game, and there may be 35 types of key event, such as a foul, corner, goal, etc. When such an event occurs, and message is triggered that contains the features required to populate

$${X}_{game}^{n} , {X}_{team}^{n} , and {X}_{player}^{n} .$$

The contextual features for

$${X}_{game - content}^{n} , {X}_{team - strength}^{n} , and {X}_{player - strength}^{n} .$$

May be obtained from a relational database of historical game data, and are generated for the first (pre-game) event. Once the features have been obtained they may be stored in a key-value database (e.g., within data store 118), so for each event trigger, the contextual features and state features from all previous events are available. The input may then be assembled from the contextual and previous features and passed to the model. The outputs may then be enclosed in a data-structure that is sent to a messaging system (e.g., within the client device(s) 108) for subsequent processing.

### Experiments

In an exemplary case, the model described herein may have been evaluated using a dataset extended amounts of data (e.g., from 62,610 games from twenty-eight competitions). An exemplary dataset may have been split into a training set with games from 8 seasons from 2016-17 through to 2023-24 (58,501 games) and a test set with games from the partial 2024-25 season up until 15 Dec. 2024 (4,109 games).

The model may make approximately 505 predictions at each of the 150 time-steps per match, consisting of predictions on 12 target metrics for each of the 40 players (starting players and substitutes), and two teams, and a prediction for the game outcome.

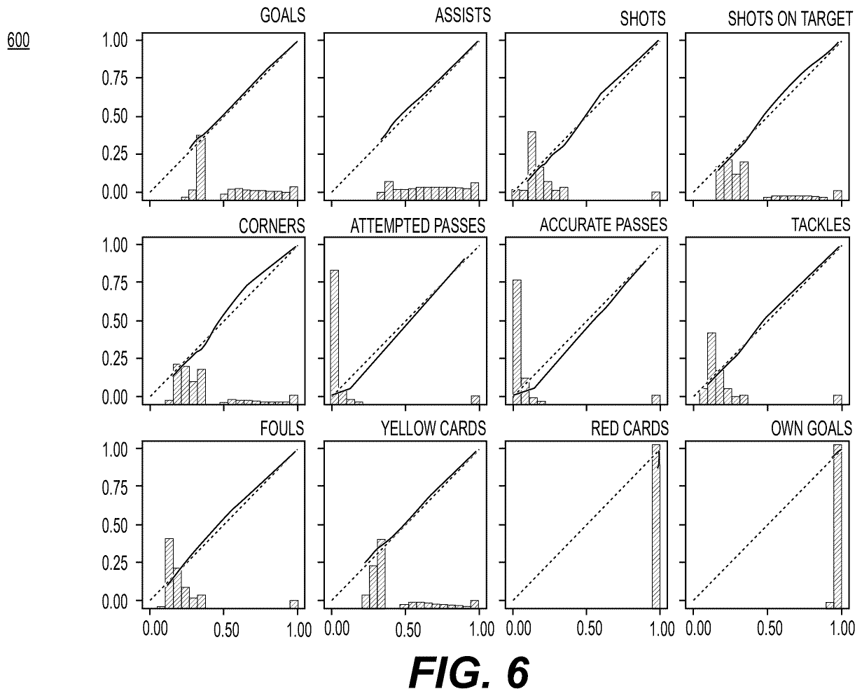

The exemplary experiment use case may have demonstrated. the extent to which the model yields consistent results across all target actions, agents, and time-steps. Given the unavailability of existing baseline models or in-game player-level data (e.g., market data), is the experiment has demonstrated the calibration of the model. Second, the exemplary experiment has been used to determine the importance of the model components to the quality of the results. For example, several ablation tests may have been conducted to evaluate the importance of the inter-agent interactions, the temporal dynamics, and the pre-game context information. In addition, we compare the performance of the axial transformer layer presented here with a “stacked” axial transformer. The results may be depicted in table 1 and FIG. 6 below.

In order to aggregate the performance over predictions for comparison, the following metrics may have been implemented: (1) Log-probability, where the log-probability assigned to the ground-truth value from the estimated distribution provided by the model. A simple average of all log-probabilities for a given agent (e.g. player or team) and target (e.g. goals, shots, passes) may computed; and (2) Calibration error where a given agent and target, the modal value of the estimated distribution (i.e. the random variable that obtains the largest probability) is compared against the ground-truth value and the binary calibration is computed.

### Model Selection

The models were trained on the training dataset of which 10% of the examples were held back for validation. For example, training occurred over 150,000 training-steps and may have taken approximately 15 hours running on a single NVIDIA A10 GPU.

Candidate models may have been created by varying the hyper-parameters used to train them, in particular the size of the latent dimension, the number of axial transformer layers, and the learning rate of the optimizer. The data batch size may have been selected as the largest possible for the GPU memory limit. For example, for the model described herein, the configuration that obtained the best outcome, determined by the total validation loss, was configured with a latent dimension of 128; 4 transformer layers; an optimizer learning rate of 0.0003; and a batch size of 30.

### Calibration

FIG. 6 is an exemplary set of calibration plots 600 for all target predictions, according to example embodiments. FIG. 6 may be applied to an exemplary soccer game, but these techniques may similarly be applied to rugby sporting events. One-vs-one calibration plots 600 for all targets, with the x-axis showing the predicted probability and the y-axis the actual probability. The dark line may represent the calibration, the dashed line may indicates the optimal calibration, and the grey histogram may display the density of predictions in each bin.

FIG. 6 contains the calibration curves for each of the action targets, using twenty bins. In general, the model obtains well-calibrated predictions, however the calibration may have been weaker for targets where there are intervals that lack support, as shown by the grey histograms, e.g. attempted and accurate passes, own-goals and red cards.

Red cards and own goals and related or similar actions, for example, are low probability events, and over the test set, the probability the model assigns to the zero category is no less than 0.84 and 0.97, respectively. In contrast, attempted and accurate passes are relatively frequent actions, and the range of possible values is large, and thus a relatively small probability is assigned to each value. In both cases, the distribution of assigned probabilities may have been highly skewed.

### Ablation Study

A key property of the model design is that it may accept and integrate the available game data using a principled approach, that allows for joint prediction on all the targets for all the agents at all time-steps. To evaluate the effectiveness of the approach to integrate the available data, experiments may have been conducted where the model was modified to disable attention to different agents and time-steps. The following ablated models may have been used: Agent attention, temporal attention, pre-game context, and stacked axial attention.

For agent attention, the temporal attention layers in the axial encoder may have been removed, so that the model would attend to other agents, but not temporally. For each agent, the pre-game context features were concatenated to the time-step features, so the available information remains the same.

For temporal attention, the agent attention layers in the axial encoder may have been removed, so predictions for each agent were made without being able to attend to the other agents.

For the pre-game context, the game context and team and player strength features may have been omitted from the model so that each in-game prediction was made with only reference to events that had occurred during the game.

For the stacked axial attention, a stacked axial attention mechanism may be used.

The summary results may be shown in Table 1 below. The model described herein may have obtained smaller mean log-probabilities than all the ablated models, thus demonstrating that effectiveness of this implementation of the axial transformer. For calibration, the model described herein obtained the best score against a plurality of the targets and was close to best for most of the remaining actions. The exception is yellow cards, where the temporal ablation is best, however the classifier may simply have been predicting the majority class in all cases: i.e. zero yellow cards.

TABLE 1
Calibration error and log-probability by each action target for each of the models
in the ablation study. The best score across the models is marked in bold.

| | Log-probability | | | | | Calibration error | | | | |
|---|---|---|---|---|---|---|---|---|---|---|
| | | | | Ours w/o | | | | | Ours w/o | |
| | | Ours w/o | Ours w/o | pre- | Ours w/ | | Ours w/o | Ours w/o | pre- | Ours w/ |
| | Ours | agent | temporal | game | stacked | Ours | agent | temporal | game | stacked |
| Goals | −0.111 | −0.114 | −0.124 | −0.124 | −0.112 | 0.002 | 0.013 | 0.004 | 0.014 | 0.002 |
| Assists | −0.088 | −0.090 | −0.098 | −0.094 | −0.089 | 0.001 | 0.002 | 0.004 | 0.001 | 0.001 |
| Shots | −0.515 | −0.532 | −0.575 | −0.597 | −0.520 | 0.021 | 0.022 | 0.028 | 0.044 | 0.021 |
| Shots on | −0.260 | −0.266 | −0.289 | −0.296 | −0.262 | 0.016 | 0.018 | 0.011 | 0.031 | 0.015 |
| target | | | | | | | | | | |
| Corners | −0.289 | −0.299 | −0.323 | −0.320 | −0.292 | 0.019 | 0.020 | 0.013 | 0.030 | 0.017 |
| Attempted | −3.039 | −3.333 | −3.501 | −3.735 | −3.062 | 0.074 | 0.093 | 0.093 | 0.102 | 0.076 |
| passes | | | | | | | | | | |
| Accurate | −2.765 | −3.002 | −3.199 | −3.403 | −2.781 | 0.075 | 0.094 | 0.096 | 0.109 | 0.078 |
| passes | | | | | | | | | | |
| Tackles | −0.608 | −0.620 | −0.674 | −0.661 | −0.614 | 0.027 | 0.025 | 0.029 | 0.028 | 0.024 |
| Fouls | −0.517 | −0.530 | −0.569 | −0.558 | −0.524 | 0.018 | 0.023 | 0.021 | 0.028 | 0.020 |
| Yellow | −0.202 | −0.209 | −0.220 | −0.211 | −0.203 | 0.019 | 0.020 | 0.004 | 0.023 | 0.019 |
| cards | | | | | | | | | | |
| Red cards | −0.018 | −0.019 | −0.020 | −0.019 | −0.019 | <0.001 | <0.001 | 0.003 | <0.001 | <0.001 |
| Own goals | −0.006 | −0.007 | −0.007 | −0.007 | −0.006 | <0.001 | <0.001 | 0.001 | <0.001 | <0.001 |

### CONCLUSION

The model described herein may predict the total number of actions performed in football matches for all players, teams and for the game overall, and that can be made multiple times as the match progresses (e.g., 75,000 predictions per game). The model may be a variation of axial attention that computes a weighted sum of the row and column attention operations. The variation may be equivalent to an instance of regular sequential self-attention, yet may be more efficient in its computation, and experiments show this variation may obtain better performance in comparison to the typical “stacked” axial attention. The model may have been empirically evaluated by ablating different components, and the results may have shown that the capacity of the model architecture to attend along both the temporal and agent dimensions, and the ability of the model to integrate different modalities of data, both contributed to the obtained performance.

### Axial Attention

As discussed above, masked axial attention is equivalent to an instance of regular masked sequential self-attention, where the grid G of embedding vectors is unraveled to the sequence S. The following is a sketch proof of this assertion.

In the following, the observation below may be used:

Observation A.1. The Softmax operator, when applied to the attention matrix A is permutation equivariant with respect to both row- and column-permutations, i.e. for any permutation matrix, we have:

### Softmax(PA)=P Softmax(A), and

### Softmax(AP)=Softmax(A)P

The proof for this observation may be as follows. The Softmax operator is applied in a row-wise manner to the A matrix and ensures that each row sums to 1, i.e.

$$\frac{1}{exp ( {A}_{i} ) * 1}$$

(exp)(Aᵢ) for row i. Thus, the rows of the input can be reordered without altering the results in any row, and the result has a corresponding reordering. Furthermore, reordering the columns of the input does not change the resulting values, as the vector dot product and scalar division operations are both permutation invariant.

Recall from above, that the input grid of embedding vectors G∈R^{H×W×D} is unraveled into a sequence S∈R^{HW×D} in row-major format, and that the permutation matrix P∈{0, 1}^{HW×HW} reorders a sequence rom column-major to row-major format.

The masked sequential self-attention operation from Equation 3 on S using the mask matrix from Equation 5, is equivalent to the masked axial attention operation, detailed in algorithm 1 described above.

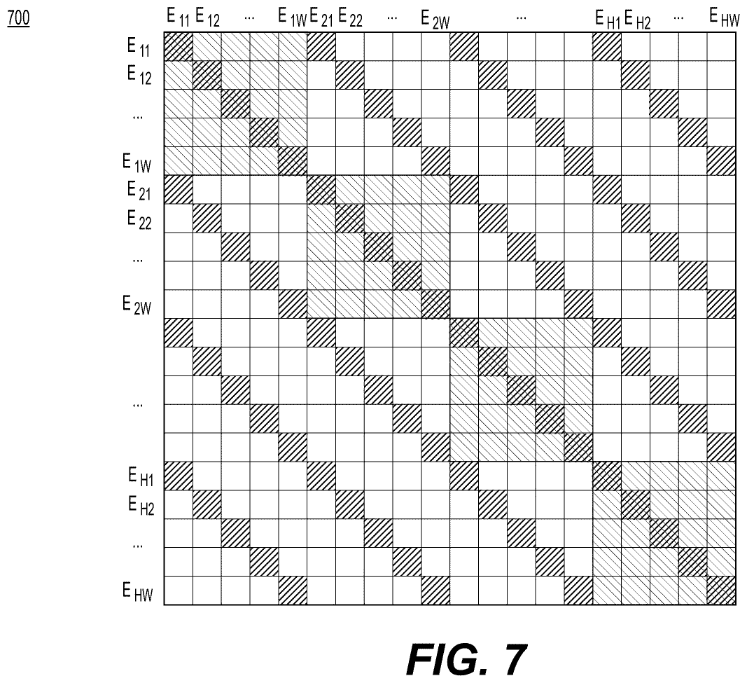

Examining the mask matrix from Equation 5. The component M^{row} ensures that (at most) an embedding vector will only attend to the vectors in the same row of G and, likewise, M^{col} ensures that (at most) the embedding vector will only attend to the vectors in the same column of G, see FIG. 7 for an illustration of the mask pattern.

FIG. 7 is an exemplary mask matrix pattern 700, according to one or more embodiments. Illustration of mask matrix pattern on unraveled sequence S for row (blue) and column (orange) axial attention, where colored cells are attended to (i.e. value of 0) and blank cells are masked (value of −∞). If the diagonal elements eᵢᵢ are masked in either of the mask matrices, then M^{row} and M^{col} are disjoint.

Given the mask M, it is sufficient to only compute the elements of the attention matrix A that are unmasked. For M^{row}, the unmasked components of A is the block diagonal matrix

$${A}^{row} := diag ( {A}_{1}^{row} , {A}_{2}^{row} , … , {A}_{H}^{row} , ) where {A}_{i}^{row} ϵ {R}^{W \times W} .$$

The unmasked components of A in M^{col} may also be a block diagonal matrix under row and column permutations. i.e., P((A^{col})P^{T} where

$${A}^{col} := diag ( {A}_{1}^{col} , {A}_{2}^{col} , … , {A}_{H}^{col} , )$$

where

$${A}_{i}^{c o l}$$

### ∈R^{H×H}.

Using the pre-condition from Algorithm 1 that either M^{row} or M^{col} masks the diagonal elements of A^{row} or A^{col}, A=A^{row}+P(A^{col})P^{T}. Furthermore, from Equation 1, the following is demonstrated:

$$\begin{matrix}Softmax ( A ) & = & Softmax ( {A}^{row} + P ( {A}^{col} ) {P}^{T} ) V & ( 8 ) \\ & = & ( \frac{{n}^{row}}{{n}^{row} + {n}^{col}} ⊙ Softmax ( {A}^{row} ) + & ( 9 ) \\ & & \frac{{n}^{col}}{{n}^{row} + {n}^{col}} ⊙ P Softmax ( {A}^{col} ) {P}^{T} ) V & \\ & = & ( \frac{{n}^{row}}{{n}^{row} + {n}^{col}} ⊙ Softmax ( {A}^{row} ) V + & ( 10 ) \\ & & \frac{{n}^{col}}{{n}^{row} + {n}^{col}} ⊙ P Softmax ( {A}^{col} ) {P}^{- 1} ) V & \\ & = & \frac{{n}^{row}}{{n}^{row} + {n}^{col}} ⊙ {R}_{row}^{′} + \frac{{n}^{col}}{{n}^{row} + {n}^{col}} ⊙ {R}_{col}^{′} & ( 11 ) \\ & = & {R}^{′} , & ( 12 )\end{matrix}$$

Where R′∈R^{HW×D} is the unraveled attention results in row-major layout. Line 9 may use Observation A.1, and the terms may be adjusted so that the attention weights from the Softmax( ) operation sum to 1. in line 10, the identity that P⁻¹≡P^{T} may be used for any permutation matrix to reorder the rows of V to column-major. Since A^{row} and A^{col} are block diagonal, multiplying by V and P⁻¹V respectively may be equivalent to multiplying each block by the corresponding submatrix of V and P⁻¹V, as is performed for-loops in lines 4 and 10 of Algorithm 1. By “re-raveling” to the grid layout, an equivalent matrix to R may be obtained from line 16 in Algorithm 1.

### Example Visualizations

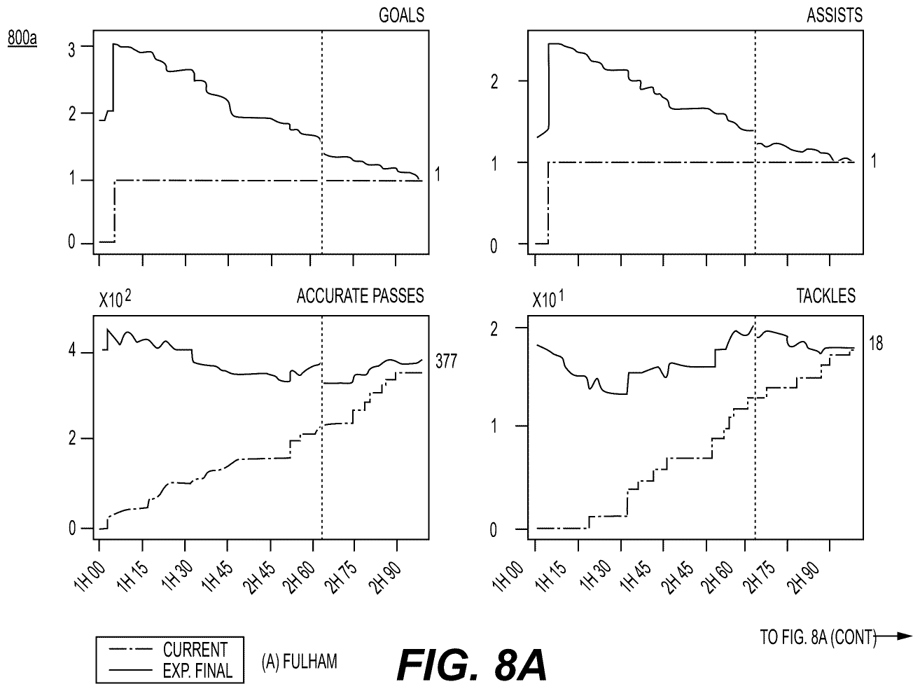

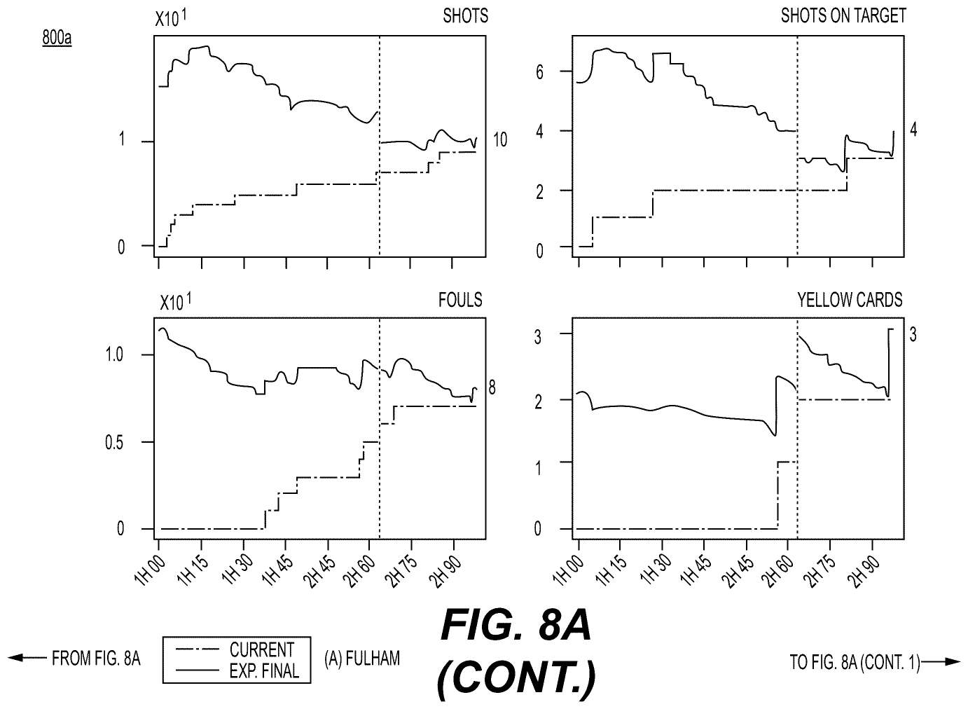

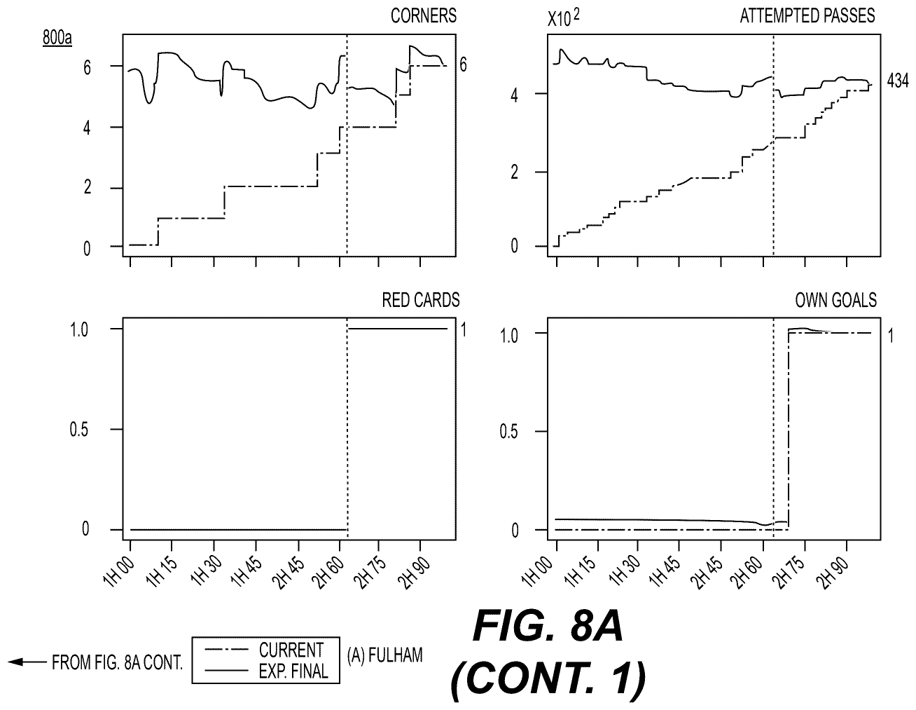

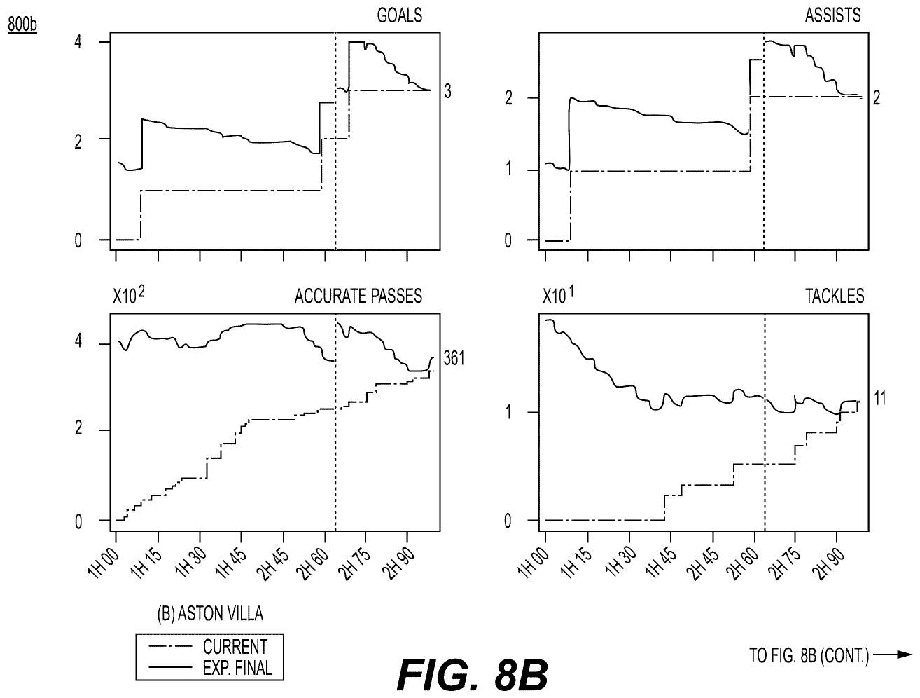

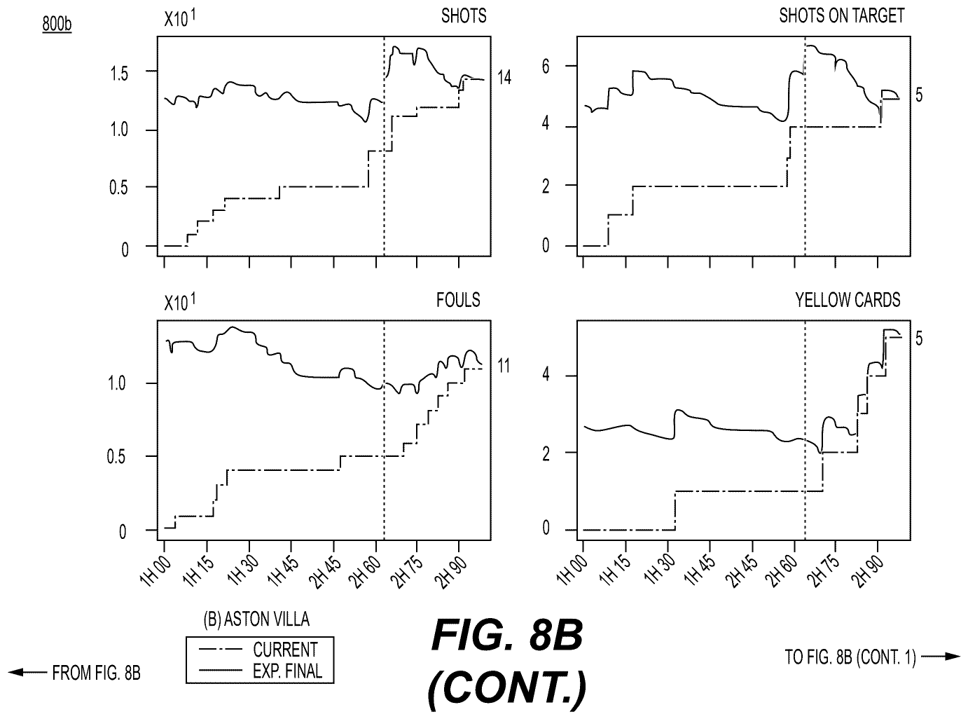

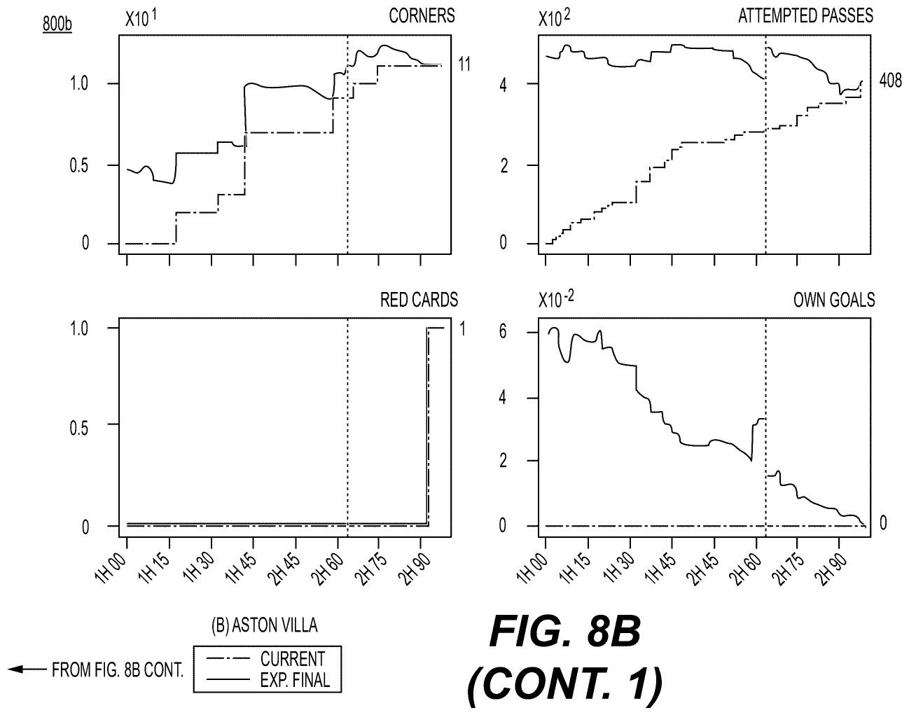

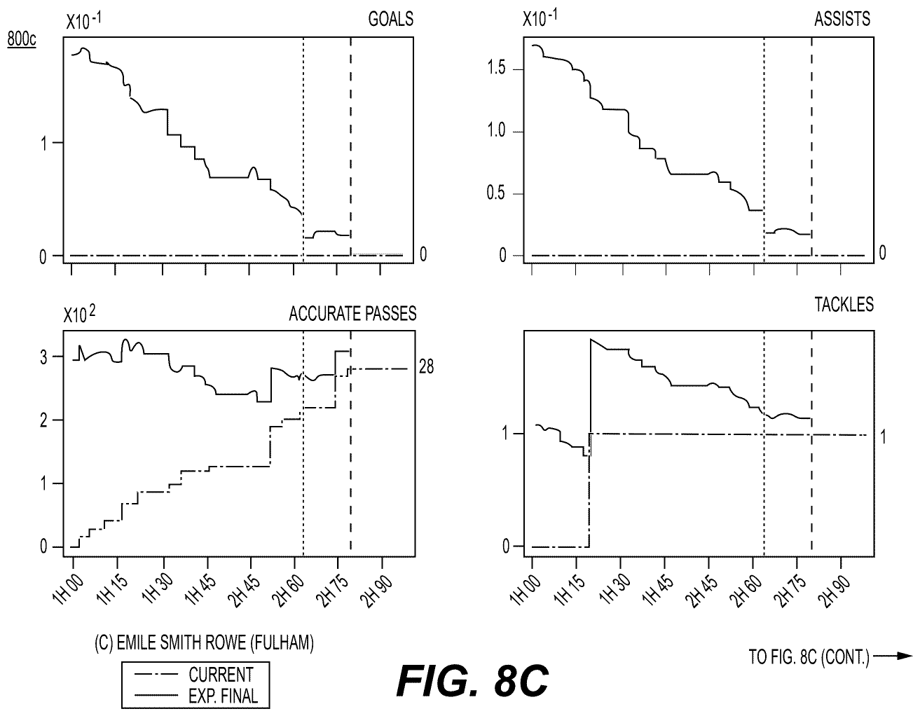

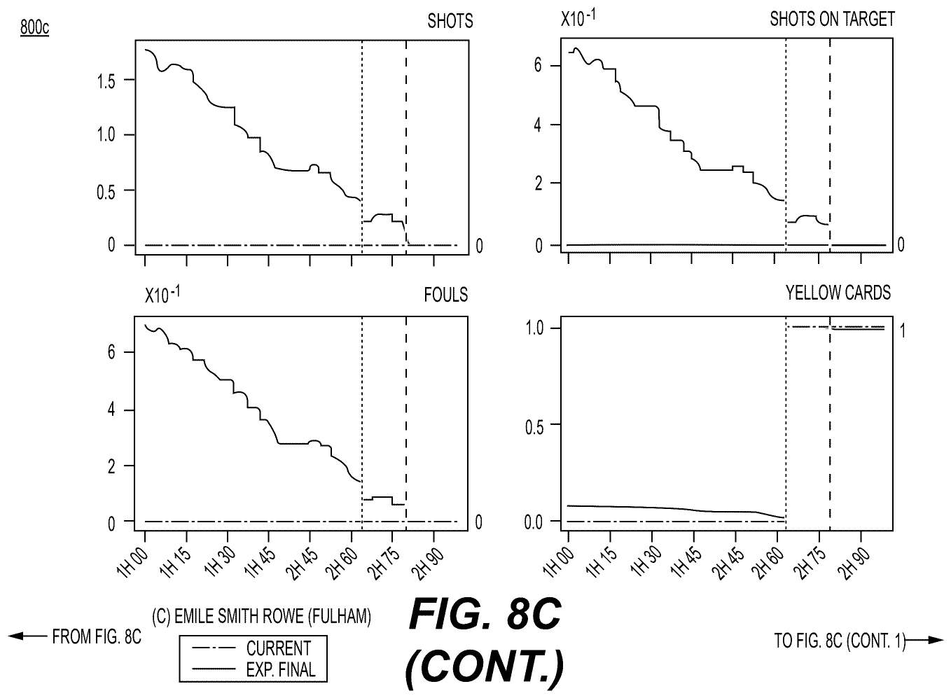

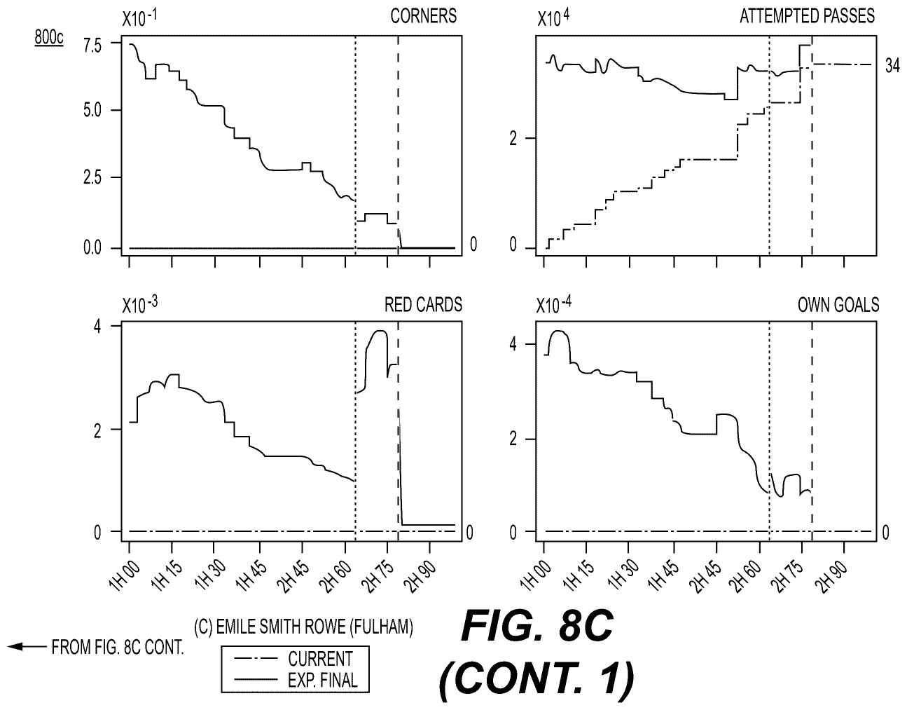

FIGS. 8A-8C are exemplary outputs of the transformer neural network for live predictions of a player for twelve target actions during a game, according to example embodiments. Although illustrated for an exemplary soccer game, the techniques may be applied to possession-based sports as described herein. For example, the FIGS. 8A-8C may demonstrate live forecasts graphed 800a, 800b, and 800c respectively for all target actions across a first team (e.g., Fullham), a second team (e.g., Aston Villa), and a player (e.g., Emile Smith Rowe). FIG. 8A-8C, in addition to FIG. 3 may be examples of predictions from the running example game Fulham vs. Aston Villa for both teams, and for one player from each team. The dotted vertical line indicates the time-step that a Fulham player may have been shown a red card and sent off. At this point, the expected action totals for both teams and players adjust to this situation, e.g. fewer expected total shots for Fulham, and more for Aston Villa, and for own goals the expected action totals adjust in the opposite direction.

In FIG. 8C, the dotted vertical line indicates the time-step when Smith Rowe was substituted. Note that for all actions, the expected future actions may be zero, with the exception of red and yellow cards, as substituted players may still receive cards, e.g. for dissent.

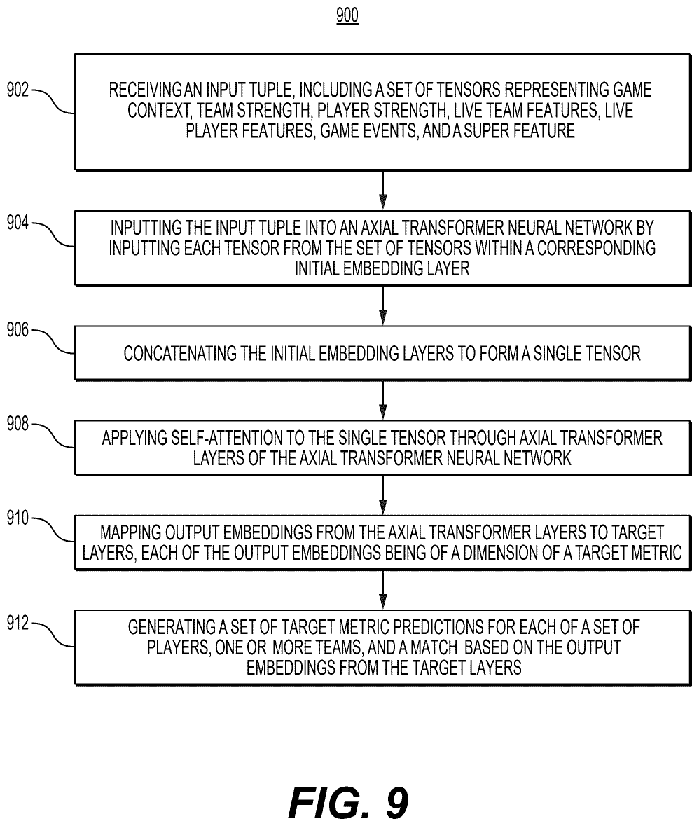

FIG. 9 is an exemplary flow diagram 900 for generating a set of predictions associated with a rugby sporting event using an axial transformer neural network, according to example embodiments. The method of FIG. 9 may be implemented by aspects of the transformer 124 of FIG. 1 and FIG. 5A. The method of FIG. 9 may be applied prior to, during, or after a sporting event occurs. In some examples, the method of FIG. 9 may be applied constantly throughout a sporting event to generate a stream of recommended user predictions throughout a sporting event. In some examples, the method of FIG. 9 may be applied after each score. In other examples, this method may be applied constantly at set time intervals throughout the game. The method may generate a set of predictions associated with a possession-based sporting event using an axial transformer neural network. The rugby games may refer to union game or rugby league games.

Step 902 may include receiving an input tuple, including a set of tensors representing game context, team strength, player strength, live team features, live player features, game events, and a super feature, wherein the super feature includes a current lineup based on a current possession in a possession based sporting event at a particular time during the sporting event. [BoMc will define a relationship between plays of rugby based on inventor answer to above]. These super features may capture specific nuances of the particular player's historical performance in particular situations/plays.

In some examples, super features including what play is occurring and which players are involved may automatically be identified based on broadcasting data. For example, a substitution or particular lineup may be automatically detected by implementing the tracking system and techniques described in FIG. 1. Further, particular scenarios such as a line-out may be identified by event data or tracking.

Step 904 may include inputting the input tuple into an axial transformer neural network, this further by including: inputting each tensor from the set of tensors within a corresponding initial embedding layer. There transformer may include a respective embedding layer for each received tensor. The transformer may accept inputs on a set of players with no implicit ordering or requirements the cardinality of the set is fixed. The transformer may accept inputs with different modalities (e.g., player, team, game-state, and both pre-game and in-game information.

Step 906 may include concatenating the initial embedding layers to form a single tensor. For example, this may include applying an exemplary algorithm to combine the set of initial embedding layers into a single tensor (e.g., a single array). Upon completion of step 906, all initial embedding information may be included in a single tensor.

Step 908 may include applying self-attention to the single tensor through axial transformer layers of the axial transformer neural network. This may include enforcing self-attention at a particular point in time across all other feature embeddings, but also self-attention just for the particular embedding across time. For example, this may include applying an autoregressive attention mask (e.g., a strict uppertriangular mask) to the row (temporal) attention in each layer so that the embedding in the current time-step I can only attend to previous time-steps.”

Step 910 may include mapping output embeddings from the axial transformer layers to target layers, each of the output embeddings being of a dimension of a target metric. For each action target and modality (e.g. player, team or game and the respective prediction), a linear layer may required that is shared over all agents and time-steps. Different distribution assumptions can be made and the only difference in the model is to the output parameter dimension of the corresponding linear layer. The model may utilize several such assumptions, including Bernoulli, Poisson, log Gaussian, and “model-free” discrete distributions

Step 912 may include generating a set of target metric predictions for each of a set of players, one or more teams, and a match, based on the output embeddings from the target layers. The target layers may map the output embedding of final transformer layers to a required feature dimension of each target metric.

Step 912 may include predicting the match statistics (in addition to predictions for the players and/or for the one or more teams). The prediction may be generated for the end of the match, but may also be for predicting what will happen at the end of each possession (try, kick, turnover) or half. The generated prediction may further predict the time for the next try or turnover. Additionally generated predictions may include how far a player will run, max speed. All of these measures may be incorporated to predict a points rating for each player or team as well. Predictions may be generated for each player in the game. Depending on the game type, this may change how many player predictions are generated. For reference, Rugby League may incorporate 13 players per team (+4 interchange) and Rugby Union may incorporate 15 players per team+7 or 8 substitutes. The predictions may further be applied to Rugby 7's (Olympic sport), as well as the Rugby League 9's (9 players per team).

The transformer may make consistent predictions for multiple separate actions. The transformer may make sequential predictions that are temporally consistent and can capture in-game dynamics such as current line-ups and playbooks being implemented.

In some examples, the transformer may further include a soft-max layer on top of the axial attention layers to provide predictions for the end of the match for all team and player predictions. The soft-max layer may further be implemented to provide predictions for certain periods of time (e.g., end of quarter, end of half, end of period, or a set period of time later).

FIG. 10 is an exemplary diagram 1000 of axial attention as described herein, according to example embodiments. The diagram depicts a set of exemplary algorithms applied by the transformer model to perform axial attention. The axial attention may enforce self-attention at the point in time across all the other super feature embeddings, but also self-attention for just that embedding across time, as further depicted in FIG. 4.

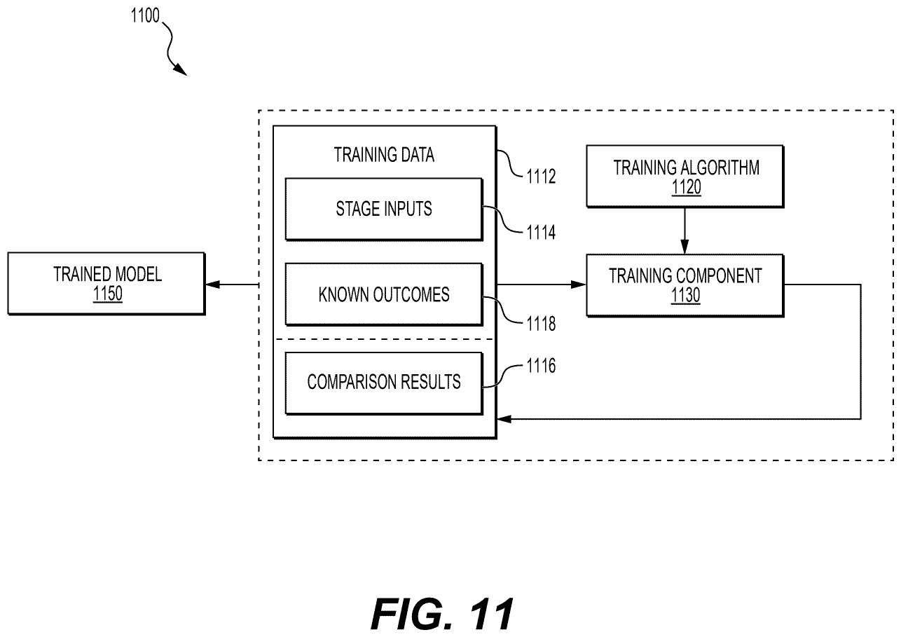

FIG. 11 depicts a flow diagram for training a machine learning model, in accordance with an aspect of the disclosed subject matter. As shown in flow diagram 1100 of FIG. 11, training data 1112 may include one or more of stage inputs 1114 and known outcomes 1118 related to a machine learning model to be trained. The stage inputs 1114 may be from any applicable source including a component or set shown in the figures provided herein. The known outcomes 1118 may be included for machine learning models generated based on supervised or semi-supervised training. An unsupervised machine learning model might not be trained using known outcomes 1118. Known outcomes 1118 may include known or desired outputs for future inputs similar to or in the same category as stage inputs 1114 that do not have corresponding known outputs.

The training data 1112 and a training algorithm 1120 may be provided to a training component 1130 that may apply the training data 1112 to the training algorithm 1120 to generate a trained machine learning model 1150. According to an implementation, the training component 1130 may be provided comparison results 1116 that compare a previous output of the corresponding machine learning model to apply the previous result to re-train the machine learning model. The comparison results 1116 may be used by the training component 1130 to update the corresponding machine learning model. The training algorithm 1120 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1100 may be a trained machine learning model 1150.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

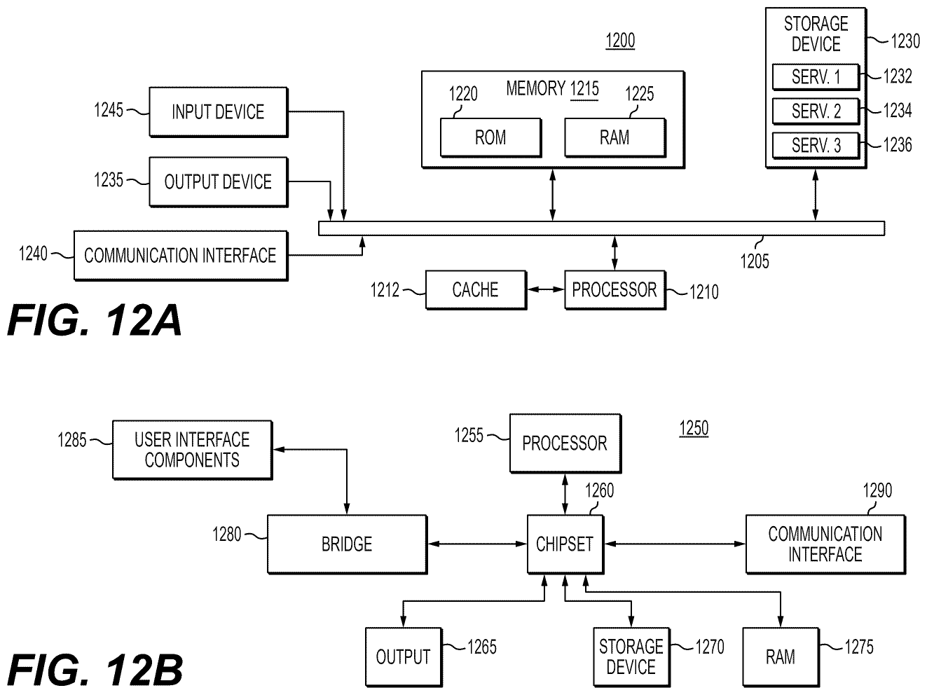

FIG. 12A illustrates an architecture of computing system 1200, according to example embodiments. System 1200 may be representative of at least a portion of organization computing system 104. One or more components of system 1200 may be in electrical communication with each other using a bus 1205. System 1200 may include a processing unit (CPU or processor) 1210 and a system bus 1205 that couples various system components including the system memory 1215, such as read only memory (ROM) 1220 and random access memory (RAM) 1225, to processor 1210. System 1200 may include a cache of high-speed memory connected directly with, in close proximity to, or integrated as part of processor 1210. System 1200 may copy data from memory 1215 and/or storage device 1230 to cache 1212 for quick access by processor 1210. In this way, cache 1212 may provide a performance boost that avoids processor 1210 delays while waiting for data. These and other modules may control or be configured to control processor 1210 to perform various actions. Other system memory 1215 may be available for use as well. Memory 1215 may include multiple different types of memory with different performance characteristics. Processor 1210 may include any general purpose processor and a hardware module or software module, such as service 1 1232, service 2 1234, and service 3 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction with the computing system 1200, an input device 1245 may represent any number of input mechanisms, such as a microphone for speech, a touch-sensitive screen for gesture or graphical input, keyboard, mouse, motion input, speech and so forth. An output device 1235 (e.g., display) may also be one or more of a number of output mechanisms known to those of skill in the art. In some instances, multimodal systems may enable a user to provide multiple types of input to communicate with computing system 1200. Communications interface 1240 may generally govern and manage the user input and system output. There is no restriction on operating on any particular hardware arrangement and therefore the basic features here may easily be substituted for improved hardware or firmware arrangements as they are developed.

Storage device 1230 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1225, read only memory (ROM) 1220, and hybrids thereof.

Storage device 1230 may include services 1232, 1234, and 1236 for controlling the processor 1210. Other hardware or software modules are contemplated. Storage device 1230 may be connected to system bus 1205. In one aspect, a hardware module that performs a particular function may include the software component stored in a computer-readable medium in connection with the necessary hardware components, such as processor 1210, bus 1205, output device 1235, and so forth, to carry out the function.

FIG. 12B illustrates a computer system 1250 having a chipset architecture that may represent at least a portion of organization computing system 104. Computer system 1250 may be an example of computer hardware, software, and firmware that may be used to implement the disclosed technology. System 1250 may include a processor 1255, representative of any number of physically and/or logically distinct resources capable of executing software, firmware, and hardware configured to perform identified computations. Processor 1255 may communicate with a chipset 1210 that may control input to and output from processor 1255. In this example, chipset 1260 outputs information to output 1265, such as a display, and may read and write information to storage device 1270, which may include magnetic media, and solid-state media, for example. Chipset 1260 may also read data from and write data to RAM 1275. A bridge 1280 for interfacing with a variety of user interface components 1285 may be provided for interfacing with chipset 1260. Such user interface components 1285 may include a keyboard, a microphone, touch detection and processing circuitry, a pointing device, such as a mouse, and so on. In general, inputs to system 1250 may come from any of a variety of sources, machine generated and/or human generated.

Chipset 1260 may also interface with one or more communication interfaces 1290 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1255 analyzing data stored in storage device 1270 or RAM 1275. Further, the machine may receive inputs from a user through user interface components 1285 and execute appropriate functions, such as browsing functions by interpreting these inputs using processor 1255.

It may be appreciated that example systems 1200 and 1250 may have more than one processor 1210 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method of generating a set of predictions associated with a rugby game using an axial transformer neural network, the method comprising:
receiving an input tuple, including a set of tensors representing game context, team strength, player strength, live team features, live player features, game events, and a super feature;
inputting the input tuple into an axial transformer neural network by inputting each tensor from the set of tensors within a corresponding initial embedding layer;
concatenating the initial embedding layers to form a single tensor;
applying self-attention to the single tensor through axial transformer layers of the axial transformer neural network;
mapping output embeddings from the axial transformer layers to target layers, each of the output embeddings being of a dimension of a target metric; and
generating a set of target metric predictions for each of a set of players, one or more teams, and a match, based on the output embeddings from the target layers.

2. The method of claim 1, wherein the rugby game is a union game, the super features includes an embedding to define elements of plays including line-outs, scrums, kicking, break-down, and ruck-and-mauls.

3. The method of claim 1, wherein the rugby games is a rugby league game, the super features includes an embedding to define how a team attacks and moves a ball during the rugby game and include an embedding for a predicted time of quick play the balls for each player in the rugby game.

4. The method of claim 1, wherein the axial transformer neural network is configured to accept inputs with different modalities.

5. The method of claim 1, wherein the super feature is determined based on broadcast data.

6. The method of claim 1, wherein the applying self-attention includes applying an autoregressive attention mask to a row in each layer of the single tensor.

7. The method of claim 1, wherein the target layers map the output embedding of final transformer layers to a required feature dimension of each target metric.

8. A system for generating a set of predictions associated with a rugby game using an axial transformer neural network, the system comprising:
a memory configured to store processor-readable instructions; and
a processor operatively connected to the memory, and configured to execute the instructions to perform operations comprising:
receiving an input tuple, including a set of tensors representing game context, team strength, player strength, live team features, live player features, game events, and a super feature;
inputting the input tuple into an axial transformer neural network by inputting each tensor from the set of tensors within a corresponding initial embedding layer;
concatenating the initial embedding layers to form a single tensor;
applying self-attention to the single tensor through axial transformer layers of the axial transformer neural network;
mapping output embeddings from the axial transformer layers to target layers, each of the output embeddings being of a dimension of a target metric; and
generating a set of target metric predictions for each of a set of players, one or more teams, and a match, based on the output embeddings from the target layers.

9. The system of claim 8, wherein the rugby game is a union game, the super features includes an embedding to define elements of plays including line-outs, scrums, kicking, break-down, and ruck-and-mauls.

10. The system of claim 8, wherein the rugby games is a rugby league game, the super features includes an embedding to define how a team attacks and moves a ball during the rugby game and include an embedding for a predicted time of quick play the balls for each player in the rugby game.

11. The system of claim 8, wherein the axial transformer neural network is configured to accept inputs with different modalities.

12. The system of claim 8, wherein the super feature is determined based on broadcast data.

13. The system of claim 8, wherein the applying self-attention includes applying an autoregressive attention mask to a row in each layer of the single tensor.

14. The system of claim 8, wherein the target layers map the output embedding of final transformer layers to a required feature dimension of each target metric.

15. A non-transitory computer readable medium configured to store processor-readable instructions, wherein when executed by a processor, the instructions perform operations comprising:
receiving an input tuple, including a set of tensors representing game context, team strength, player strength, live team features, live player features, game events, and a super feature for a rugby game;
inputting the input tuple into an axial transformer neural network by inputting each tensor from the set of tensors within a corresponding initial embedding layer;
concatenating the initial embedding layers to form a single tensor;
applying self-attention to the single tensor through axial transformer layers of the axial transformer neural network;
mapping output embeddings from the axial transformer layers to target layers, each of the output embeddings being of a dimension of a target metric; and
generating a set of target metric predictions for each of a set of players, one or more teams, and a match, based on the output embeddings from the target layers.

16. The non-transitory computer readable medium of claim 15, wherein the rugby game is a union game, the super features includes an embedding to define elements of plays including line-outs, scrums, kicking, break-down, and ruck-and-mauls.

17. The non-transitory computer readable medium of claim 15, wherein the rugby games is a rugby league game, the super features includes an embedding to define how a team attacks and moves a ball during the rugby game and include an embedding for a predicted time of quick play the balls for each player in the rugby game.

18. The non-transitory computer readable medium of claim 15, wherein the axial transformer neural network is configured to accept inputs with different modalities.

19. The non-transitory computer readable medium of claim 15, wherein the super feature is determined based on broadcast data.

20. The non-transitory computer readable medium of claim 15, wherein the applying self-attention includes applying an autoregressive attention mask to a row in each layer of the single tensor.
